(19) United States
(12) Patent Application Publication
(10) Pub. No.: US 2026/0018167 A1
(43) Pub. Date: Jan. 15, 2026

(54) DISCOURSE ENGINE(S) FOR PROVIDING QUALITATIVE FEEDBACK

(71) Applicant: Microsoft Technology Licensing, LLC, Redmond, WA (US)

(72) Inventors: Michael THOLFSEN, Newcastle, WA (US); Tyler Jonathan CITRIN, Springfield, NJ (US); Samantha Ruth FISHER, Brooklyn, NY (US); Tiffany Bich TRUONG, Kirkland, WA (US)

(21) Appl. No.: 18/770,253

(22) Filed: Jul. 11, 2024

(51) Int. Cl. G10L 15/22; G10L 15/26; H04L 67/306

(52) U.S. Cl. CPC G10L 15/22; G10L 15/26; H04L 67/306; G10L 2015/225

(57) ABSTRACT

Systems and methods for a discourse engine for providing qualitative feedback are described herein. In an example, a discourse engine may determine a first debate topic for the debate exercise and receive first debate content from a client device. The discourse engine may then generate first response content based on the first debate content and the first debate topic. The discourse engine may also determine one or more qualitative aspects for providing debate feedback to the client device and generate debate feedback based on the first debate content and the one or more qualitative aspects. The discourse engine may provide the debate feedback to the client device.

### TECHNICAL FIELD

Aspects of the disclosure are related to the field of computer software applications and services and, in particular, to discourse engines for providing qualitative feedback to foster engaging and enhanced learning environments for developing speech and debate skills.

### BACKGROUND

Learning to give a speech or participate in a debate is crucial for personal and professional development. These activities enhance critical thinking, improve communication skills, and build confidence. Through speech, individuals learn to organize their thoughts, articulate ideas clearly, and engage an audience effectively. Debate, on the other hand, fosters the ability to construct logical arguments, consider multiple perspectives, and respond to opposing viewpoints. Both skills are invaluable in a wide range of contexts, from academic settings to the workplace, and even in everyday interactions. By mastering the art of speech and debate, individuals not only become more persuasive and influential but also more adept at navigating complex discussions and making informed decisions.

Conventional techniques for developing speech and debate skills often fall short due to their reliance on self-assessment and lack of immediate, personalized feedback. Practicing alone or merely preparing speeches without presenting them to an audience limits the speaker's ability to gauge the effectiveness of their delivery, argumentation, and overall impact. Without another person to provide qualitative feedback-detailed, constructive evaluations-speakers miss out on critical insights into their performance. This feedback is essential for identifying specific areas of improvement, such as clarity, persuasiveness, and engagement techniques. The absence of a knowledgeable listener or coach to offer real-time reactions and critiques significantly hampers the refinement of one's speaking and debating abilities, ultimately slowing down the learning process and hindering progress.

As such, there is a need for a discourse engine, and its related functions, for providing qualitative feedback on forensic activity, such as a speech or debate. That is, there is a need for an enhanced approach for developing speech and debate skills that can provide invaluable insights into the effectiveness of a selected communication strategy, clarity of arguments, and impact on an audience, even when a user is practicing alone.

### SUMMARY

Technology disclosed herein includes software applications and services that provide a discourse engine, and its related functions, for generating qualitative feedback for forensic activities, such as speech and debate exercises. As will be expanded on in greater detail below, the discourse engine provided herein may determine an indication to start an exercise, such as a speech or debate exercise. For example, a client device may request to start an exercise. Responsive to the indication to start, the discourse engine may determine the type of exercise to be performed, such as a speech exercise or a debate exercise.

If the discourse engine determines that a speech exercise is selected, then the discourse engine may determine a speech type for the exercise. Based on the speech type, the discourse engine may determine one or more qualitative aspects for evaluating of the speech exercise. In some embodiments, the discourse engine may also determine a topic for the speech exercise, such as generating a speech topic based on the speech type and/or information relating to the requesting client device.

Once the speech type and qualitative aspects are determined, the discourse engine may start the speech exercise. During the speech exercise, a user, such as a student, may speak. His or her speech may be captured by the client device and transmitted to the discourse engine. In some embodiments, the discourse engine may generate a transcript of the speech. From the speech the discourse engine may determine speech content. Based on the speech content and the qualitative aspects, the discourse engine may generate speech feedback. In some embodiments, the discourse engine may send the speech feedback to a second client device for review and input. In such cases, responsive to receiving input on the speech feedback, the discourse engine may generate qualitative feedback for the speech exercise and transmit the qualitative feedback to the client device. The qualitative feedback may incorporate the input from the second client device into the speech feedback. In some cases, the speech feedback may be sent directly to the client device as the qualitative feedback without review by the second client device.

In embodiments where the discourse engine determines that the debate exercise is selected, then the discourse engine may determine a debate type for the debate exercise, and in some cases, a debate topic for the debate exercise. The debate topic may be generated by the discourse engine based on the debate type and/or information associated with the client device. Upon initiation of the debate exercise, the discourse engine may receive debate content from the client device. Similar to the speech exercise, the debate content may be based on a speech performed by a user that is captured by the client device and transmitted to the discourse engine. From the speech, the discourse engine may determine the debate content.

Responsive to determining the debate content, the discourse engine may generate a debate response. The debate response may be a reply to the debate content. For example, the debate response may be a counter point or a statement that contrasts the debate content. Following the debate response, the user may generate subsequent debate content, such as responding to the debate response. As can be appreciated, the user and the discourse engine may exchange content and responses throughout the debate exercise.

Once the debate exercise is completed, the discourse engine may generate debate feedback based on the user's performance of the debate exercise. For example, based on the debate content, and in some cases, the debate responses, exchanged between the client device and the discourse engine, the discourse engine may generate the debate feedback. The debate feedback may comprise an evaluation of this exchange in view of one or more qualitative aspects, which may be determined based on the debate type and/or user information. Similar to the speech exercise, in some embodiments, the debate feedback may be provided to a second client device for review of the debate feedback. The second client device may provide input on the debate feedback for which the discourse engine may incorporate into the debate feedback to generate qualitative feedback for the debate exercise. The qualitative feedback may be provided to the client device. In some cases, the debate feedback may be the same as the qualitative feedback.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a discourse engine for providing qualitative feedback on one or more forensic activities, according to an embodiment herein;

FIG. 2 illustrates a brief operational scenario to further highlight an application of the discourse engine, according to an embodiment provided herein;

FIG. 3 illustrates a system for providing a discourse engine and related functions, according to an embodiment herein;

FIG. 4 illustrates a process for providing the discourse engine and its related functions, according to an embodiment herein;

FIG. 5 illustrates another process for providing the discourse engine and its related functions, according to an embodiment herein;

FIG. 6 illustrates an example prompt of various speech types, according to an embodiment herein;

FIG. 7 illustrates an example prompt providing various topics for a speech exercise, according to an embodiment herein;

FIG. 8 illustrates an example prompt illustrating various qualitative categories for which feedback may be generated, according to an embodiment herein;

FIG. 9 illustrates an example prompt illustrating a customizable qualitative aspect prompt, according to an embodiment herein;

FIG. 10 illustrates another example prompt illustrating qualitative aspects, according to an embodiment herein;

FIG. 11 illustrates an example prompt of a speech exercise recording, according to an embodiment herein;

FIG. 12 illustrates an example graphical user interface (GUI) providing qualitative feedback for a respective exercise, according to an embodiment herein;

FIG. 13 illustrates an example transcript of a speech, according to an embodiment herein;

FIG. 14 illustrates an example prompt of various debate types, according to an embodiment herein;

FIG. 15 illustrates an example prompt illustrating debate content and debate responses exchanged between a user and a discourse engine, according to an embodiment herein;

FIG. 16 illustrates an example prompt illustrating qualitative feedback generated by a discourse engine for a debate exercise, according to an embodiment herein;

FIG. 17 illustrates an example prompt providing alternative personas for providing qualitative feedback, according to an embodiment herein; and

FIG. 18 shows an example client device suitable for providing a discourse engine and related functions, according to an embodiment herein.

### DETAILED DESCRIPTION

Forensic activities, such as speech and debate, permeate all facets of life, from personal interactions to professional endeavors. Mastering these skills cultivates essential abilities that are indispensable in navigating various contexts. In personal settings, effective communication fosters stronger relationships, facilitates understanding, and empowers individuals to articulate their ideas confidently. Professionally, these skills are pivotal in leadership, negotiation, and advocacy roles, where the ability to influence and persuade is paramount. Whether in boardrooms, classrooms, community forums, or everyday conversations, proficiency in speech and debate enables individuals to convey complex information persuasively, critically analyze diverse perspectives, and adapt to evolving circumstances with clarity and conviction. Thus, the universal applicability of forensic activities underscores their pivotal role in empowering individuals to succeed in an interconnected world.

Despite the widespread importance of forensic activities, many individuals struggle to fully develop or refine these skills due to the critical need for external feedback. Without the insights and constructive criticism provided by another person—whether a mentor, coach, peer, or judge—it becomes challenging to identify blind spots or areas for improvement. Self-assessment, while valuable to a degree, often lacks the depth and objectivity necessary for substantial growth. The absence of timely and targeted feedback hinders the refinement of delivery techniques, the construction of compelling arguments, and the adaptation to different audiences or debating styles. This limitation underscores the necessity for structured environments that facilitate regular and detailed forensic feedback, ensuring that individuals can systematically enhance their abilities and confidently navigate the complexities of communication and debate in diverse settings.

While current techniques may incorporate platforms that offer feedback without the presence of an audience, such feedback often focuses primarily on quantitative aspects rather than qualitative insights. These platforms may provide metrics on elements such as speech timing, filler words, and pacing, which are undeniably important for improving delivery mechanics. However, they often fall short in assessing the nuanced qualitative aspects critical to effective communication and debate. Qualitative feedback, encompassing factors like the persuasiveness of arguments, clarity of expression, emotional resonance, and audience engagement, under conventional approaches, requires human judgment and expertise to discern. As those skilled in the art can appreciate, both quantitative and qualitative feedback are required to provide a comprehensive evaluation that addresses both technical proficiency and rhetorical effectiveness. In other words, qualitative feedback, along with quantitative feedback, is essential for nurturing well-rounded communicators who can not only speak effectively but also persuade and inspire through their words and ideas.

To address these and other shortcomings, an example discourse engine, and its related functions, is provided herein to provide qualitative feedback on forensic activity, such as a speech exercise or a debate exercise. As will be expanded on below, the discourse engine provided herein may receive speech or debate content from a user, such as from a respective client device. Responsive to receiving the speech or debate content, the discourse engine may generate qualitative feedback based on the received content and provide the qualitative feedback to the user. The qualitative feedback may include evaluation of various qualitative aspects of the received content, such as language use, message clarity, and engagement strategies.

In some embodiments, the qualitative aspects for which the speech or debate content is generated may be based on an exercise type selected and/or a topic selected. For example, if the speech type is selected to be a persuasive speech, then the qualitative aspects used to generate the qualitative feedback may focus on message clarity, emotional and intellectual appeal, and a call to action. In contrast, if the speech type is selected to be a personal story, then the qualitative aspects used to generate the qualitative feedback may focus on style, organization, and engagement strategies.

In scenarios where a user selects an exercise type of debate, the discourse engine may engage in discourse with the user on a selected topic. That is, the discourse engine may receive debate content from a user and determine a stance on the selected topic from the debate content (e.g., for or against a stance on the selected topic). Then the discourse engine may generate a response to the debate content that counters the stance of the debate content. The user may then respond to the response from the discourse engine with subsequent debate content. As can be appreciated, the user and the discourse engine may continue to debate in this manner until the debate exercise is completed. Once the debate exercise is completed, the discourse engine may generate qualitative feedback on the user's debate content, such as on the structure of the user's argument, whether or not supporting evidence was provided, and how clearly the user communicated his or her stance.

The discourse engine, by allowing users to practice speech and debate skills individually and receive qualitative feedback on such practice, offers numerous advantages and benefits over conventional approaches. For example, the discourse engine provides a personalized approach that allows individuals to hone their abilities at their own pace, focusing on specific areas of improvement tailored to their unique strengths and weaknesses. Moreover, by providing qualitative feedback, the discourse engine provides detailed insights that highlight both the strengths and areas for improvement in the content of the speech or debate, going beyond quantitative feedback that typically focuses more on delivery aspects (e.g., pacing, timing, filler words). That is, the discourse engine provides constructive critique which fosters a deeper understanding of effective communication techniques for users, encouraging continuous growth and development. Additionally, individualized practice and feedback enable the development of critical thinking and persuasive skills in a supportive environment, boosting confidence and competence. Overall, the discourse engine provided herein not only enhances proficiency in speech and debate but also cultivates a lifelong ability to articulate ideas clearly, engage in meaningful discourse, and navigate complex interactions with poise and effectiveness.

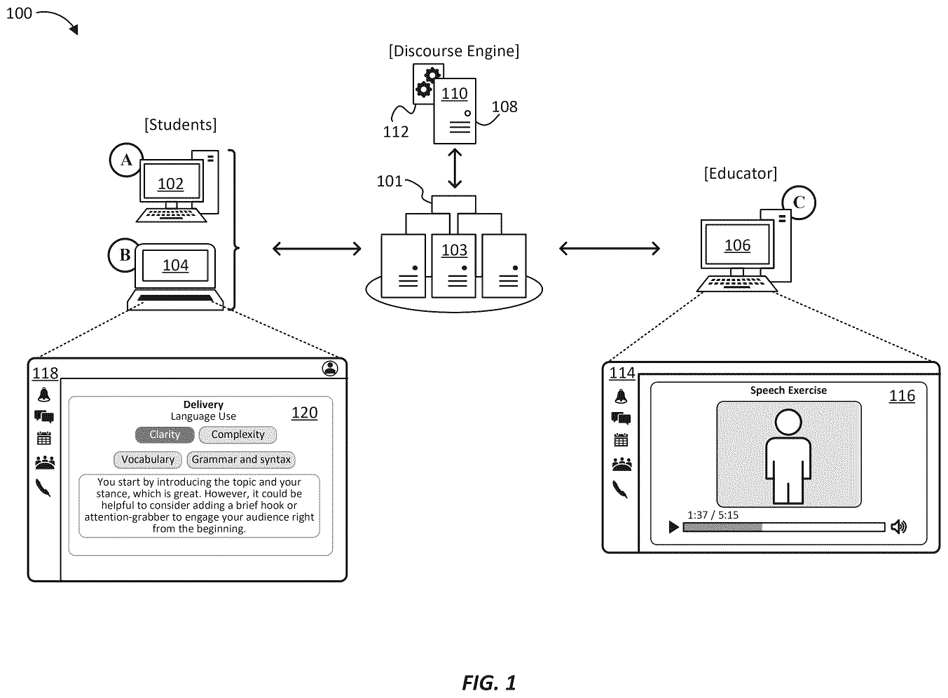

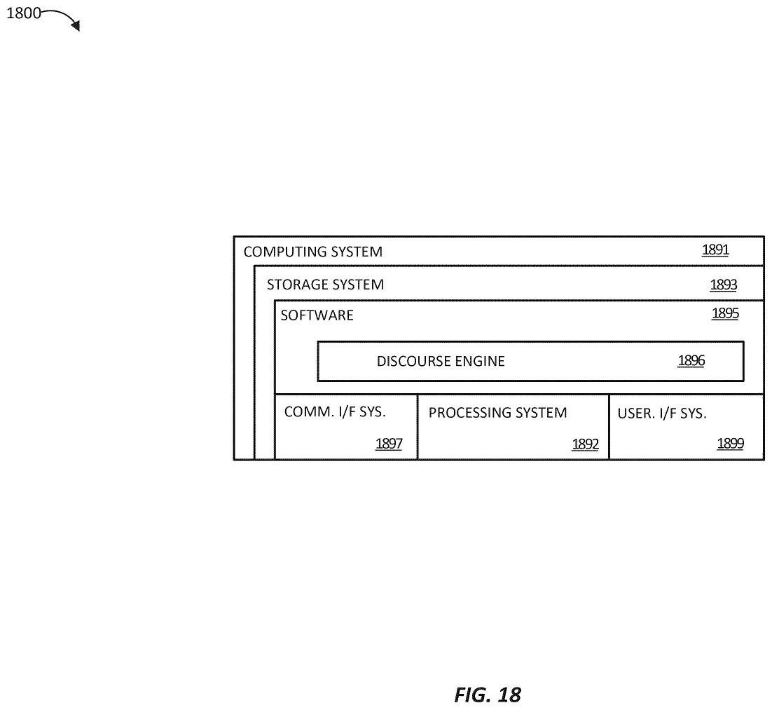

Turning now to FIG. 1, FIG. 1 illustrates an operational environment 100 providing a discourse engine that generates qualitative feedback on one or more forensic activities, according to an embodiment herein. As illustrated, the operational environment 100 includes an application service 101, a discourse engine 108, and client devices 102, 104 and 106. The application service 101 employs one or more server computers 103 co-located with respect to each other or distributed across one or more data centers. Example servers include web servers, application servers, virtual or physical servers, or any combination or variation thereof, of which computing system 1801 in FIG. 18 is broadly representative.

The client devices 102, 104, and 106 communicate with application service 101 via one or more internets and intranets, the Internet, wired and wireless networks, local area networks (LANs), wide area networks (WANs), or any other type of network or combination thereof. Examples of the client devices 102, 104, and 106 may include personal computers, tablet computers, mobile phones, gaming consoles, wearable devices, Internet of Things (IoT) devices, and any other suitable devices, of which computing system 1801 in FIG. 18 is also broadly representative.

Broadly speaking, the application service 101 provides software application services to end points, such as the client devices 102, 104, and 106, examples of which include productivity software for creating content (e.g., word processing, spreadsheets, and presentations), email software, and collaboration software. The client devices 102, 104, and 106 load and execute software applications locally that interface with services and resources provided by the application service 101. The applications may be natively installed and executed applications, web-based applications that execute in the context of a local browser application, mobile applications, streaming applications, or any other suitable type of application. Example services and resources provided by the application service 101 include front-end servers, application servers, content storage services, authorization and authentication services, and the like.

The application service 101 also includes an integration with the discourse engine 108, which is capable of generating qualitative feedback for forensic activities (e.g., speech or debate) performed by the client devices 102 and 104. As will be described in greater detail below, one or more of the client devices 102 and 104 may request to perform a forensic exercise, such as a speech exercise or debate exercise, via the application service 101. For example, the application service 101 may provide a discourse application through which the discourse engine 108 provides one or more of its functions. As the client devices 102 and 104 participate in the selected exercise, the discourse engine 108 may receive content from the client devices 102 and 104. Based on the received content, the discourse engine 108 may generate qualitative feedback for the exercise. As used herein, qualitative feedback refers to feedback on the substance and content of the speech or debate. Examples include, but are not limited to, language use, rhetorical techniques, style, organization, message clarity, quality of information, engagement strategies, emotional and intellectual appeal, call to action, supporting evidence, structure of argument, depth of content, and the like.

As noted above, qualitative feedback is distinct from quantitative feedback. Quantitative feedback typically addresses measurable elements such as timing, vocal delivery, and adherence to format, providing an objective assessment of performance aspects. It focuses on how the content is delivered, including factors like filler words (e.g., “like,” “uh”), inclusive language, speed/pacing, eye contact, body posture, gesture usage, and intonation. In contrast, qualitative feedback offers detailed, nuanced evaluations of an individual's arguments, structure, audience engagement, and content, aiming to enhance the effectiveness and clarity of the message.

To provide these functions, the discourse engine 108 employs one or more server computers 110 co-located with respect to each other or distributed across one or more data centers, of which computing system 1801 in FIG. 18 is broadly representative. In some embodiments, the discourse engine 108 hosts a content generator 112 on server computers 110 as well. In other embodiments, the content generator 112 may be hosted separately from the discourse engine 108, such as by a third party. As will be described in greater detail below, the discourse engine 108 interacts with a user via the content generator 112, such as a large language model (LLM).

The application service 101 hosts or provides an application, such as a discourse application, through which users of the client devices 102 and 104, user A and user B, respectively, can practice or develop their speech or debate skills. For example, the application service 101 may provide or host an educational application through which exercises are prepared by an educator, such as the user of the client device 106 (user C). Users A and B may be students in the illustrated example. As such, users A and B may perform and complete one or more forensic exercises provided by the application service 101 via a corresponding discourse application. As used herein, a forensic exercise may be a speech exercise or a debate exercise during which a user verbally delivers content on a respective topic. For example, if the topic is cellphones in the classroom, then a speech exercise may include a persuasive speech on why cell phones should be allowed in the classroom and a debate exercise may be a debate on whether or not cell phones should be allowed in the classroom. As will be described in greater detail below, during a debate exercise the users A and B may engage in discourse with the discourse engine 108 on the respective topic.

Once the users A and B complete a respective exercise, the discourse engine 108 may generate qualitative feedback on the respective user's performance on the exercise. Following the above example, if the user A delivered the persuasive speech on allowance of cell phones in the classroom, the discourse engine 108 may generate qualitative feedback on that speech. In particular, the discourse engine 108 may determine qualitative aspects for generating the feedback and generate the qualitative feedback based on those qualitative aspects. As will be described in greater detail below, the qualitative aspects may be selected by the users A or B, by a supervising user, such as the user C, and/or the discourse engine 108.

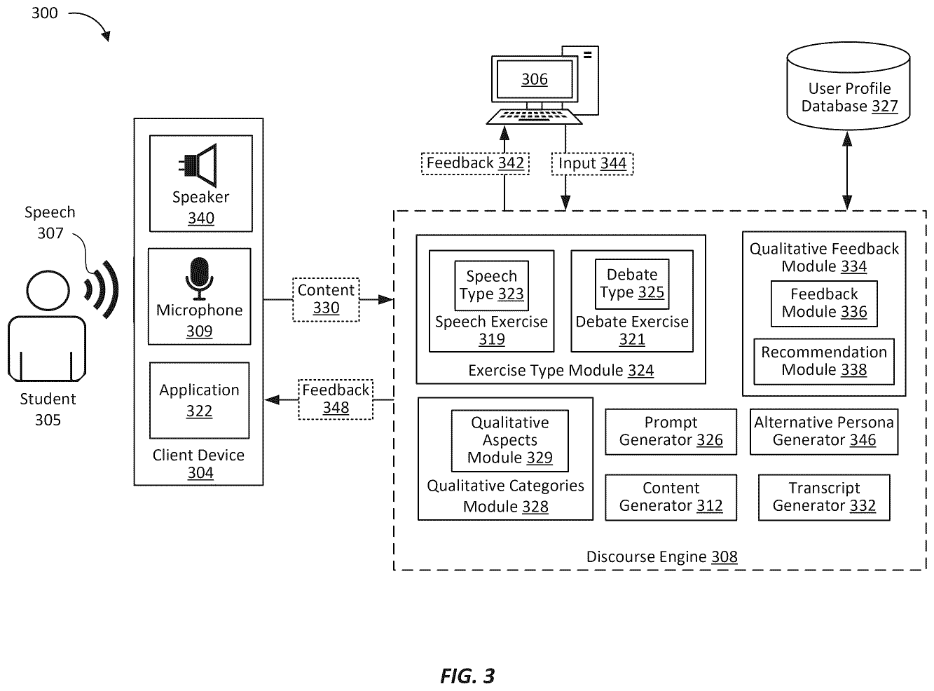

To generate the qualitative feedback, the discourse engine 108 may submit the forensic content (e.g., speech content or debate content) received from a respective client device, along with the qualitative aspects to the content generator 112. The content generator may generate the qualitative feedback based on the forensic content and the qualitative aspects. In some embodiments, additional information may be used to generate the qualitative feedback, such as user information associated with the client devices 102 or 104, the topic, type of speech or debate, and/or previous feedback. In still other embodiments, the qualitative feedback may be generated based on a feedback persona such to generate the qualitative feedback in the format of a particular person or persona (e.g., a particular character or actor). Each of these variations are described in greater detail with respect to FIGS. 3-17.

Once generated by the discourse engine 108, the qualitative feedback may be provided to user C, who may be an educator in this scenario. In such an example, the discourse engine 108 may generate a video or audio recording 116 of the exercise performed by a user of the respective client device 102 or 104. Along with the recording 116, the discourse engine 108 may provide the qualitative feedback to the client device 106. The user C may view the recording 116 and/or the qualitative feedback via a user interface 114 via an application executing on the client device 106. As illustrated, the user interface 114 may include the recording 116 of the exercise as completed by user B via the client device 104. As will be described in greater detail below, the user C may review the qualitative feedback and in some cases the recording 116 to determine whether any modifications to the feedback are required.

Once the user C provides input on the qualitative feedback, such as approval of the qualitative feedback, a qualitative feedback 120 may be provided to user B via a user interface 118 of an application (e.g., discourse application) executing on the client device 104. User B can interact with the qualitative feedback 120 via the user interface 118, such as reviewing the feedback. As will be described in greater detail below, in some cases the qualitative feedback 120 may include a transcript of the speech or debate content, along with feedback to specific portions of the transcript. Generation of the qualitative feedback 120 is described in greater detail below with respect to FIGS. 3-17.

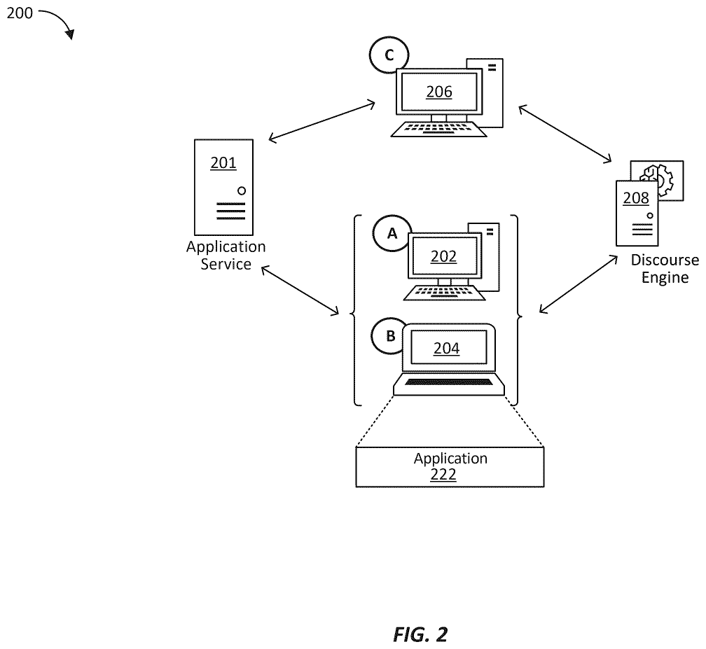

Turning now to FIG. 2, FIG. 2 illustrates a brief operational scenario 200 to further highlight an application of the discourse engine, according to an embodiment provided herein. As shown, in operational scenario 200, there are two observed users (e.g., students), users A and B, and a reviewing user (e.g., educator), user C. Users A and B may operate the client devices 202 and 204, respectively, which may be the same or similar to the client devices 102 and 104 described above with respect to FIG. 1. Similarly, user C may operate the client device 206, which may be the same or similar to the client device 106. It should be appreciated while the following description includes a reviewing user associated with the client device 204, in some embodiments, there may not be a reviewing user. In other words, in some embodiments, the operational scenario 200 may include a sole user, such as user A or user B associated with a respective client device 202 or 204.

Following the above example involving the persuasive speech exercise, user B may open an application, such as a discourse application 222 (e.g., an education-based collaboration application), to begin a forensic exercise, such as a speech exercise. To open the application 222, the client device 204 may communicate with an application service 201, which may be the same or similar to the application service 101. The application service 201 may initiate and operate the discourse application 222 on the client device 204. Once the application is open on the client device 204, the user B may begin the speech exercise within the discourse application 222 by, for example, selecting a type and topic for the exercise.

As noted above, the discourse application 222 provides enhanced and adaptive forensic exercises as generated by discourse engine 208. The discourse engine 208 may be the same or similar to the discourse engine 108. As such, in some embodiments, upon initiating the discourse application 222 on the client device 204, software corresponding to the discourse engine 208 may also be initiated. That is, settings associated with the discourse application 222 may indicate a certain exercise is handled (e.g., generated and evaluated) by the discourse engine 208. For example, if user C is an educator, user C may have prepared a forensic exercise to be completed in the discourse application 222, such as a speech exercise as part of a class assignment. As part of the exercise, user C may have selected a setting to have the discourse engine 208 generate qualitative feedback for the exercise, and indicated that a user, here user B, complete the exercise within a given time period. The user C may also select a setting to observe the completion of the exercise, including reviewing the qualitative feedback generated by the discourse engine 108 prior to providing the feedback to the user B. As such, the discourse engine 108 may host or otherwise generate a forensic exercise, based on the input from the user C, receive content as it is generated by the user B (e.g., video or audio feeds) via the discourse application 222, and generate qualitative feedback of the user B's performance on the forensic exercise.

Turning now to FIG. 3, a system 300 for providing a discourse engine 308 is illustrated, according to an embodiment herein. The system 300 includes the discourse engine 308 and a client device 304, which may be the same or similar to the discourse engine 108 and the client device 104, respectively. In the illustrated example, the discourse engine 308 provides enhanced and adaptive forensic exercises for a student 305 of the client device 304. For ease of discussion the user of the client device 304 is described as a student within an educational environment, however, it should be appreciated that other scenarios are also contemplated, such as the student 305 using the discourse engine 308 in a personal capacity.

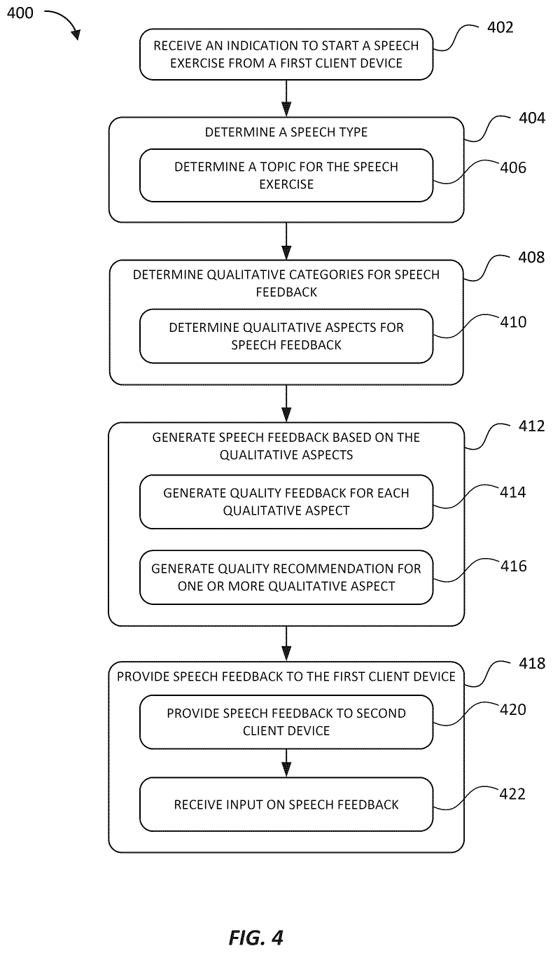

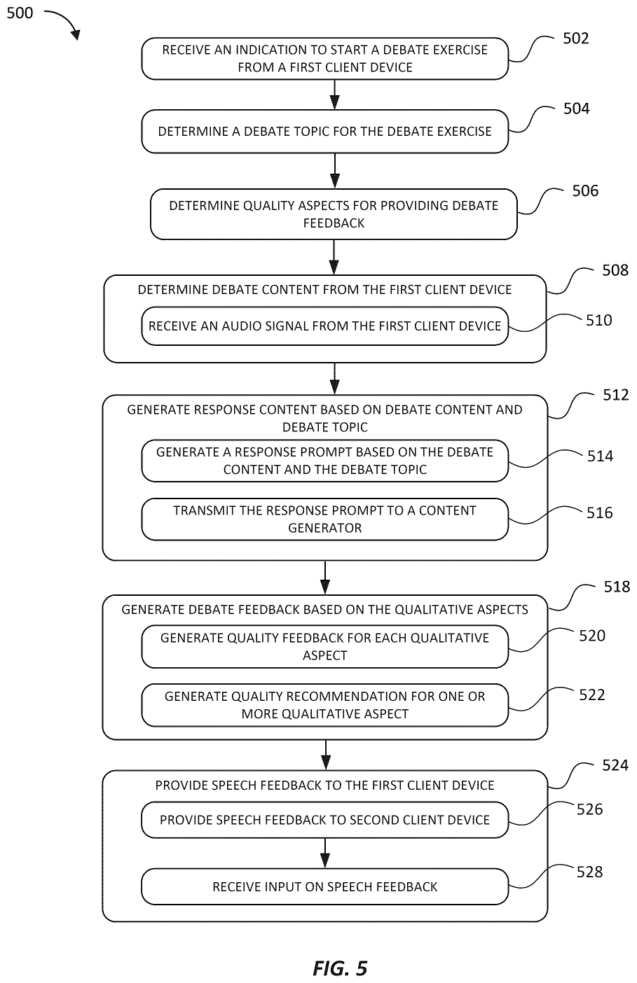

For ease of explanation, FIG. 3 is described in combination with FIGS. 4-17. As such, the following discussion may refer to various figures in turn. Moreover, as noted above, the discourse engine 308 may provide various types of forensic exercises, such as a speech exercise and a debate exercise. As such, FIG. 3 is described with relation to FIGS. 4 and 5, each of which provide a process for providing qualitative feedback on a respective type of forensic exercise. That is, FIG. 4 illustrates a process 400 for providing the discourse engine 308 and its related functions, such as for providing qualitative feedback on a speech exercise, according to an embodiment herein, and FIG. 5 illustrates a process 500 for providing the discourse engine 308 and its related functions, such as for providing qualitative feedback on a debate exercise, according to an embodiment herein. The processes 400 and/or 500 may also be noted as the discourse engine processes 400 and/or 500 herein. Although the processes 400 and/or 500 are described with respect to components and elements of FIG. 3, it should be appreciated the one or more steps of the processes 400 and/or 500 may be executed or applied to components or elements of any other Figure provided herein. For ease of discussion, FIG. 3 will first be described with respect to FIG. 4 and then with respect to FIG. 5.

To begin, the student 305 corresponding to the client device 304 may start a forensic exercise. For example, the client device 304 provides an indication, such as opening a discourse application 322, to begin a forensic exercise. Responsive to opening the discourse application 322, the student 305 may be provided with an option to select a type of forensic exercise. For example, the discourse engine 308 may include an exercise type module 324 that may prompt the student 305 to select between a speech exercise 319 and a debate exercise 321. If the student 305 selects the speech exercise 319, the discourse engine 308 may perform one or more steps of the process 400, while if the student 305 selects the debate exercise 321, then the discourse engine 308 may perform one or more steps of the process 500. As noted above, the following discussion will first describe the process 400 and then process 500, for ease of explanation.

Once within the discourse application 322, the student 305 may select the speech exercise 319. Responsive to the student's 305 selection, the discourse engine 308 may receive an indication to start a speech exercise (402). Upon selection of the speech exercise 319, the discourse engine 308 may select a speech type 323 (404), and in some cases, determine a topic for the speech exercise 319 (406). It should be appreciated that while the following discussion involves the student 305 selecting a speech type and/or topic, in some embodiments, a reviewing user, such as an educator, may make these selections. In such cases, the student 305 may simply select to start the speech exercise 319, via the discourse application 322.

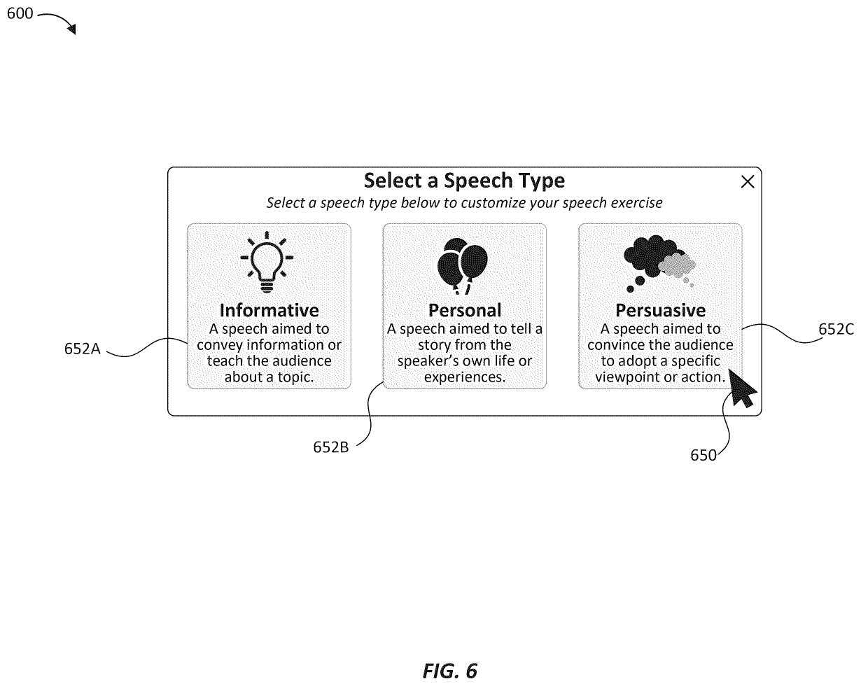

Referring now to FIG. 6, an illustrative prompt 600 of various speech types 652A-C are illustrated, according to an embodiment herein. The prompt 600 may be generated by the discourse engine 308 and provided to the client device 304, such as via the discourse application 322. As shown, the prompt 600 provides three speech types 652A-C from which the student 305 can select from for the speech exercise 319. The speech type 652A is for an informative speech type, the speech type 652B is for a personal speech type, and the speech type 652C is for a persuasive speech type. It should be appreciated that the speech types 652A-C are illustrative and any other speech types, as well as any number of speech types may be provided via the prompt 600.

As can be appreciated, different types of speeches, such as informative, personal, and persuasive speeches, require distinct content, organization, and delivery techniques to be engaging and effective. Informative speeches focus on clear, factual content and logical organization to educate the audience, personal speeches emphasize storytelling and emotional connection, and persuasive speeches use compelling arguments and rhetorical strategies to influence the audience's beliefs or actions. To allow users to practice different speech types and styles, and as will be described in greater detail below, the discourse engine 308 may customize the qualitative feedback based on a selected speech type. As such, when the user selects a desired speech type, such as the speech type 652C, with a cursor 650 (or any other means of selection), the discourse engine 308 may tailor the speech exercise 319, in particular the qualitative feedback to the selected speech type.

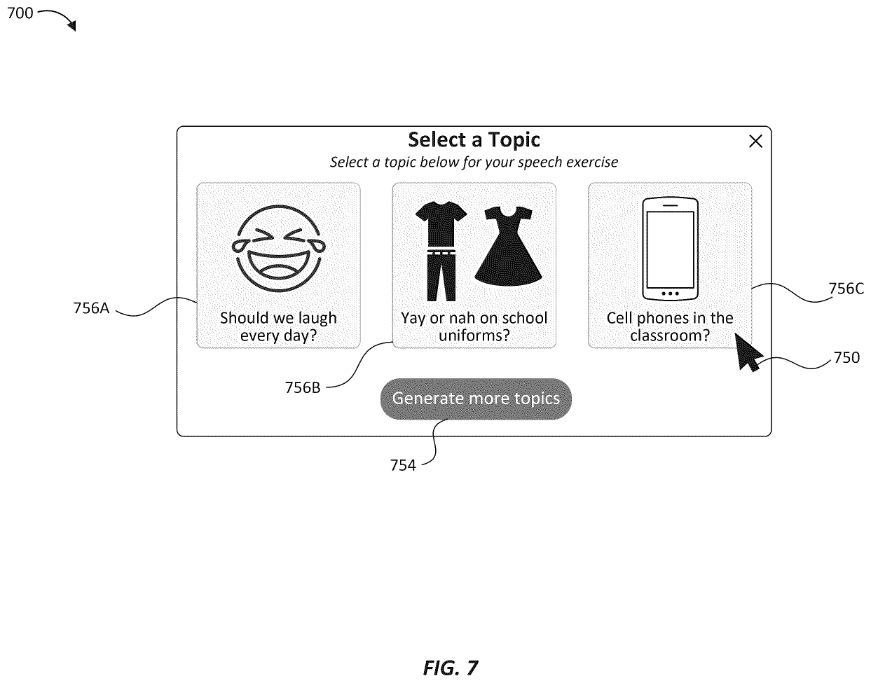

In some embodiments, in addition to selecting the speech type 652A, the discourse engine 308 may also determine a topic or speech topic for the speech exercise 319 (406). In some embodiments, a reviewing user, such as an educator may assign a topic of the speech exercise 319, while in other embodiments, the student 305 may select a topic for the speech exercise 319. Referring now to FIG. 7, an example prompt 700 providing various topics 756A-C for a speech exercise is illustrated, according to an embodiment herein. As shown, the prompt 700 may provide a topic 756A having the prompt “should we laugh every day?”, a topic 756B having the prompt “yay or nah on school uniforms?”, and a topic 756C having the prompt “cell phones in the classroom?” In some embodiments, one or more of these topics 756A-C may be set or selected by a reviewing user, such as an educator, while in other embodiments, the student 305 may select one of the topics 756A-C for the speech exercise 319. While only the three topics 756A-C are illustrated, it should be appreciated that any number of topics 756A-C may be provided via the prompt 700.

In some embodiments, the discourse engine 308 may generate one or more of the topics 756A-C or additional topics. In one example, the discourse engine 308 may generate the topics 756A-C based on the student 305. To generate the topics 756A-C, the discourse engine 308 may determine a user profile associated with the student 305, such as identifying a user profile based on login information used by the student 305 to access the discourse application 322. In some embodiments, the discourse engine 308 may query a user profile database 327 to determine user information associated with the student 305 and then determine topics that are relevant and appropriate for the student 305 based on the user information. For example, based on the user profile and/or information from the database 327, the discourse engine 308 may determine a grade level of the student 305 and generate the topics 756A-C based on the student 305 being in an intermediary grade level. As can be appreciated, if the student 305 was in elementary school, then different topics may be more relevant or appropriate for the speech exercise 319.

If the student 305, upon reviewing the topics 756A-C, wants to generate more topics, then student 305 may select the option 754 to generate more topics. Responsive to selection of the option 754, the discourse engine 308 may generate one or more topics. To generate additional topics, the discourse engine 308 may generate a topic prompt. In particular, the discourse engine 308 may include a prompt generator 326 that may generate a topic prompt requesting additional topics for the speech exercise 319. The prompt generator 326 may generate a topic prompt based on the selected speech type 323, and in some embodiments, user profile information, such as a grade level or class associated with the student 305. For example, if the speech exercise 319 is assigned as part of a 5^{th} grade history class, then the prompt generator 326 may generate a topic prompt requesting additional topics for an informative speech for a 5^{th} grade history class. As can be appreciated, the prompt generator 326 may tailor the topic prompt to various information such that the respectively generated topics are relevant and appropriate for the student 305.

Once prepared, the topic prompt may be provided to a content generator 312. As described above, the content generator 312, which may be the same or similar to the content generator 112, may be hosted by the discourse engine 308, or in some embodiments, may be hosted by the application service 101 and/or a third party. The content generator 112 may be a text-to-text generative model, such as an LLM, or may be a text-to-image generative model or a multimodal (e.g., text and images) generative model. Examples include generative pre-trained transformer models. Although only one content generator 312 is illustrated, it should be appreciated that the discourse engine 308 may include more than one content generator 312, including different types of content generators 312.

Responsive to receiving the topic prompt, the content generator 312 may generate one or more additional topics based on the topic prompt and provide the additional topics to the discourse engine 308. In some cases, the topics 756A-C may be generated in a similar manner, such as the discourse engine 308 generating the topic prompt responsive to the selection of the speech type 323. Regardless, when a topic that engages the student 305 is present, the student 305 may select the desired topic, such as the topic 756C with a cursor 750.

As noted above, the discourse engine 308 generates qualitative feedback based on the student's 305 performance of a respective exercise, such as the speech exercise 319. As part of the qualitative feedback, various qualitative aspects of the student's 305 performance may be evaluated. In some embodiments, the qualitative aspects of an exercise may be bucketed into different qualitative categories. In other words, evaluation of a respective performance may be performed by evaluating different qualitative categories, each category containing one or more qualitative aspects. And as noted above, since each speech type involves a different format, style, content, and arrangement, the different qualitative categories and/or aspects may be required, depending on the selected speech type.

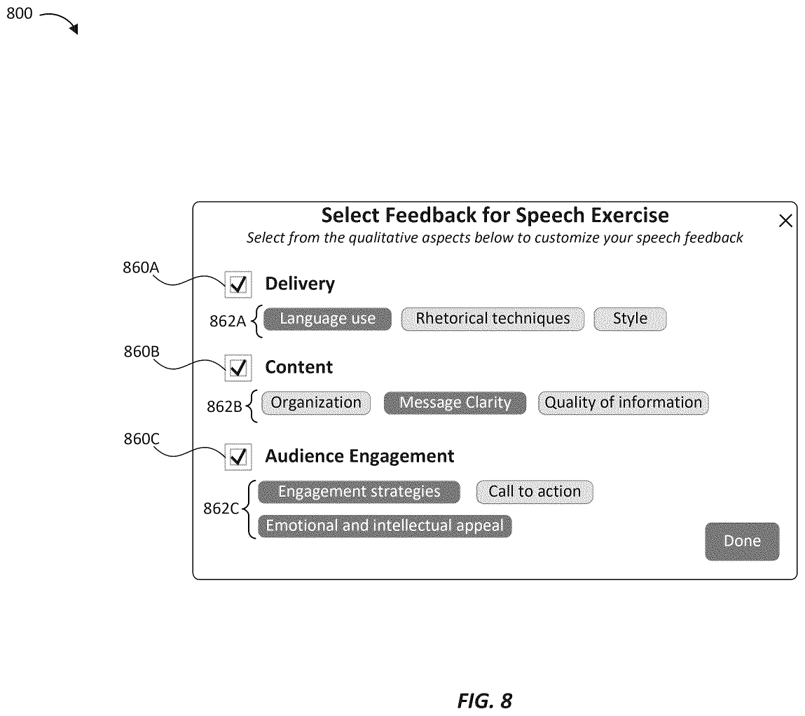

Referring now to FIGS. 8-10, various example prompts are provided illustrating qualitative aspects for generated qualitative feedback, according to an embodiment herein. Starting with FIG. 8, example prompt 800 illustrates various qualitative categories 860A-C for which feedback may be generated for a respective exercise. Following the above example, responsive to the selection of the persuasive speech type 652C, the discourse engine 308, in particular a feedback categories module 328, may determine the qualitative categories 860A-C for generating the qualitative feedback of the speech exercise 319 (408). As illustrated, the qualitative categories 860A-C include Delivery, Content, and Audience Engagement. It should be appreciated that other qualitative categories 860A-C may be determined, depending on the exercise and/or type.

As shown, each of the qualitative categories 860A-C may include one or more qualitative aspects 862A-C. In an example, the feedback categories module 328 include a qualitative aspects module 329 that generates the qualitative aspects 862A-C based on the determined qualitative categories 860A-C. Once generated, the prompt 800 may be provided to the student 305 (or the reviewing user) depending on the configuration such that the student 305 may select which of the qualitative aspects 862A-C the speech exercise 319 should be evaluated by. The darkened qualitative aspects of the qualitative aspects 862A-C may indicate that the student 305 selects these aspects for the qualitative feedback. Based on the student's 305 selection, the discourse engine 308 may determine one or more qualitative aspects for the speech exercise 319 (410).

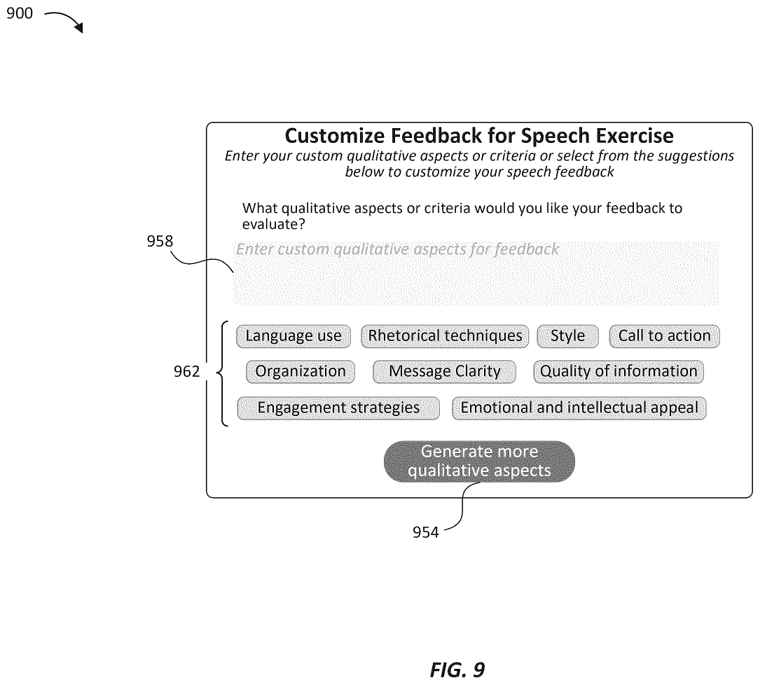

In some embodiments, the qualitative aspects may be determined without respect to a qualitative category. Referring now to FIG. 9, an example prompt 900 illustrating a customizable qualitative aspect prompt is provided, according to an embodiment herein. As shown, the prompt 900 may include an input field 958 into which a user, such as the student 305 or reviewing user, can enter a custom qualitative aspect for which to generate the qualitative feedback. Additionally, the prompt 900 may include qualitative aspects 962 for the student 305 (or the reviewing user) to select. If the student 305 wants additional qualitative aspects 962 to be generated, an option 954 may be provided.

Upon selection of the option 954, the discourse engine 308 may generate additional qualitative aspects for the speech exercise 319. In particular, the qualitative aspects module 328 may generate additional qualitative aspects for the speech exercise 319. For example, the qualitative aspects module 328 may coordinate with the prompt generator 326 to generate an aspects prompt requesting additional qualitative aspects for evaluating the speech exercise 319. The aspects prompt may include information such as the speech type 323, speech topic, and/or information relating to the student 305, as noted above. The aspects prompt may then be submitted to the content generator 312, which in turn generates additional qualitative aspects to be included in the prompt 900. From the prompt 900, the student 305 can select one or more of the qualitative aspects to be evaluated during the speech exercise 319.

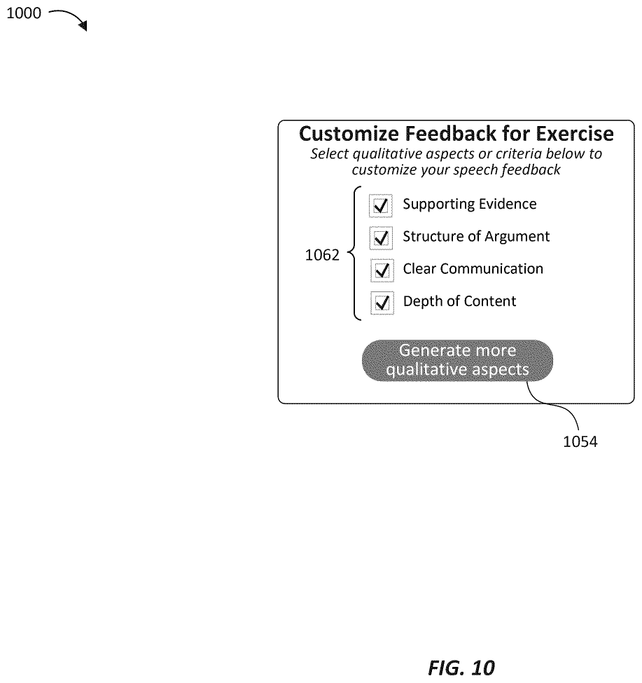

Referring now to FIG. 10, another example prompt 1000 illustrating qualitative aspects 1062 is provided, according to an embodiment herein. As shown, the prompt 1000 may include a listing of qualitative aspects 1062 that may be generated by the discourse engine 308 that the student 305 can select or deselect. The prompt 1000 also includes an option 1054 for generating additional qualitative aspects for the feedback. If selected, the option 1054 may cause the discourse engine 308 to generate additional qualitative aspects, as described above.

Once the speech type 323, and in some cases the topic and/or qualitative aspects, are determined, the student 305 may start the speech exercise 319. To perform the speech exercise 319, the student 305 may deliver a speech 307 which may be captured by the client device 304. In particular, a microphone 309 associated with the client device 304 may capture the speech 307. In some embodiments, a video may be captured as well of the student's 305 performance. As the speech 307, and in some cases video, are captured by the client device 304, the respective content 330 may be transmitted to the discourse engine 308, such as by the application 322 via the application service 101.

In some embodiments, the content 330 may be an audio signal, audio stream, or audio recording of the speech 307. In such cases, responsive to receiving the content 330, the discourse engine 308 may generate a transcript of the speech 307. In particular, the discourse engine 308 may include a transcript generator 332 that may generate a transcript of the speech 307, based on the content 330. As can be appreciated, the content 330 may be continuously transmitted from the client device 304 to the discourse engine 308, while in other embodiments, the content 330 may be periodically transmitted to the discourse engine 308, such after each sentence is completed. Additionally, while the transcript generator 332 is illustrated as remote from the client device 304, in some cases, the transcript generator 332 may be locally executed on the client device 304 such that the content 330 contains a transcript of the speech 307.

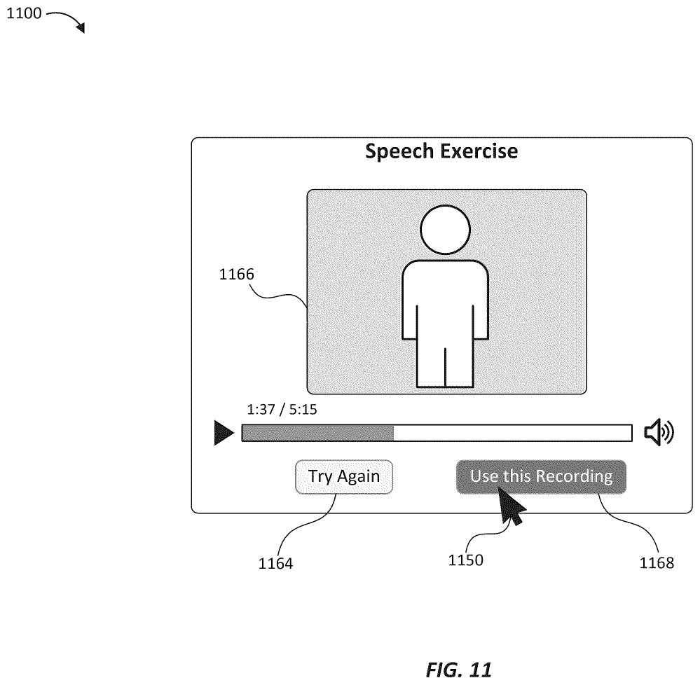

Referring now to FIG. 11, a prompt 1100 of a speech exercise recording 1166 is illustrated, according to an embodiment herein. Following the above example, once the student 305 performs the speech exercise 319, the discourse engine 308 may generate the prompt 1100 containing the recording 1166 of the speech exercise 319. The recording 1166 may be an audio recording or may be a video recording with respective audio of the student 305 performing the respective exercise. By providing the recording 1166 to the client device 304, the student 305 can review the recording 1166 and determine whether to attempt the speech exercise 319 again or submit the recorded attempt. If the student 305 determines that another attempt is necessary, the student 305 may select the option 1164 to try again. Responsive to the option 1164, the discourse engine 308 may prompt the user to restart the speech exercise 319. In some cases, this may include selecting a different speech type 323 and/or speech topic, while in other cases, the previously selected speech type 323 and/or speech topic may be maintained.

If the student 305 determines that the recording 1166 is sufficient for the speech exercise 319, the student 305 may select the option 1168 to use the recording 1166. By selecting the option 1168 with a cursor 1150, the student 305 may indicate that qualitative feedback should be generated based on the recording 1166. It should be appreciated that in alternative embodiments, the qualitative may be automatically generated upon completion of the speech exercise 319, such as when the student 305 finishes recording the speech 307.

Once the discourse engine 308 determines that the speech exercise 319 is completed, such as by selection of the option 1168 or an end of the speech 307, the discourse engine 308 may generate speech feedback 342 based on the speech exercise 319 (412). In particular, the discourse engine 308 may include a qualitative feedback module 334 that generates speech feedback 342 based on the content 330 received from the student 305. To generate the speech feedback 342, the discourse engine may generate quality feedback for each of the qualitative aspects (414), and in some cases, generate a quality recommendation for each qualitative aspect (416).

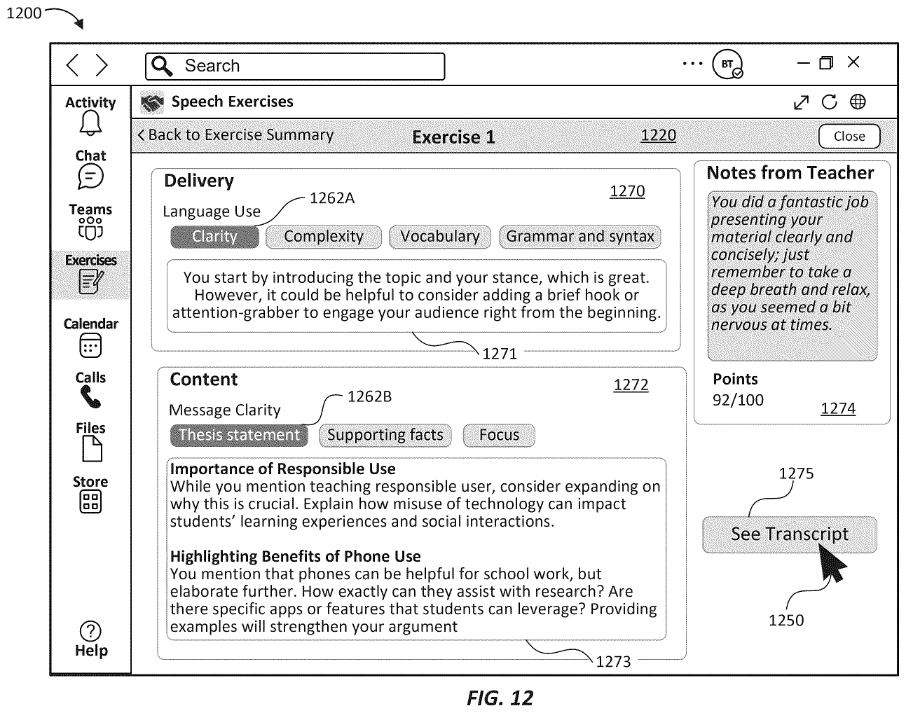

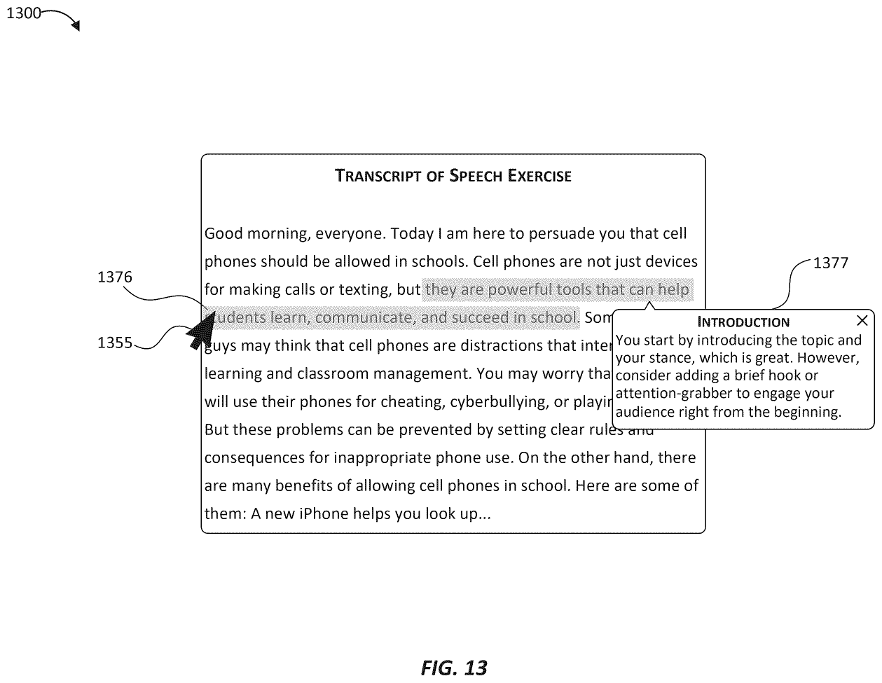

To generate the speech feedback 342, the qualitative feedback module 334 may coordinate with the prompt generator 326 to generate a feedback prompt. The feedback prompt may include the content 330, or in some cases, a transcript of the content 330, as well as the selected qualitative aspects. In some embodiments, the feedback prompt may also include the speech type, the speech topic, and/or user profile information, as noted above. The feedback prompt may be submitted to the content generator 312 which may, in turn, generate the speech feedback. In some embodiments, a feedback module 336 of the qualitative feedback module 334 may generate a quality feedback for each of the qualitative aspects and a recommendation module 338 of the qualitative feedback module 334 may generate a recommendation for each of the qualitative aspects. In other words, for each of the selected qualitative aspects, the qualitative feedback module 334 may generate a quality feedback, such as highlighting the student's 305 performance with relation to a particular qualitative aspect, as well as a recommendation on how to develop or improve on that aspect. Examples of quality feedback, as well as quality recommendations are described in greater detail below with respect to FIGS. 12-13.

Once the speech feedback 342 is generated by the discourse engine 308, the discourse engine 308 may provide the feedback to the client device 304 (418). In some embodiments, however, prior to providing the feedback to the client device 304, the discourse engine 308 may provide the speech feedback 342 to a reviewing user, such as an educator associated with a client device 306 (420), which may be the same or similar to the client devices 106 and 206. In some cases, along with the speech feedback 342, the discourse engine 308 may transmit the recording 1166 to allow the reviewing user the ability to evaluate the student's 305 performance of the speech exercise 319 as well. Additionally, as can be appreciated, having a reviewing user evaluate the speech feedback 342 before it is provided to the student 305 may ensure accuracy, relevance, and appropriateness of the speech feedback 342. In other words, by providing the speech feedback 342 to the client device 306, the discourse engine 308 helps maintain high-quality standards, providing users, such as the student 305, with reliable and effective learning materials.

Upon reviewing the speech feedback 342, and in some cases the recording 1166, the reviewing user may add additional remarks to the speech feedback 342 and/or may approve the speech feedback 342. Any input 344 may be provided to the discourse engine 308 (422), which may in turn incorporate the input 344 to generate qualitative feedback 348. In some cases, the input 344 may merely be approval of the speech feedback 342. In such cases, the qualitative feedback 348 may be the same or similar to the speech feedback 342.

Referring now to FIG. 12, a GUI 1200 providing qualitative feedback 1220 for a respective exercise is illustrated, according to an embodiment herein. The GUI 1200 may be provided to the client device 304 such as to provide the qualitative feedback 348 to the student 305. As such, the illustrated qualitative feedback 1220 may depict a portion or all of the qualitative feedback 348 transmitted from the discourse engine 308 to the client device 304.

As shown, the qualitative feedback 1220 includes qualitative categories 1270 and 1272. For each of the qualitative categories 1270 and 1272, the qualitative feedback 1220 includes quality feedback 1271 and 1273, respectively. The qualitative category 1270 is for delivery of the speech 307 and focuses on a qualitative aspect 1262A for the clarity of delivery. As such, the quality feedback 1271 provides feedback on the student's 305 clarity during delivery of the speech 307. In the illustrated example, the quality feedback 1271 also includes a quality recommendation, noting that “it could be helpful to consider adding a brief hook or attention-grabber to engage your audience right from the beginning.”

The qualitative category 1272 is on the content of the speech 307 and focuses on the quality aspect 1262B for the thesis statement for the speech 307. As such, the quality feedback 1273 provides feedback on the student's 305 thesis statement made during the speech 307. As illustrated, the quality feedback 1273 highlights two different areas of feedback, one with respect to the “Importance of Responsible Use” and the second with respect to “Highlighting Benefits of Phone Use.” In addition to the feedback provided by the qualitative categories 1270 and 1272, the qualitative feedback 1220 may include feedback or input 1274 from a reviewing user. For example, the feedback 1274 may include the input 344 received from the client device 306 responsive to receiving the speech feedback 342.

As illustrated by the GUI 1200, the qualitative feedback 1220 provides critiques and highlights opportunities for improvement with respect to the substance and content of the speech 307. By providing the qualitative feedback 1120 on the substance and content of the speech 307, the discourse engine 308 offers significant benefits beyond conventional approaches, which mainly focus on quantitative feedback. The qualitative feedback 1220 generated by the discourse engine 308 delves into the nuances of the student's 305 arguments, the coherence of their structure, and the clarity of their message, fostering a deeper understanding of effective communication. The discourse engine 308 also encourages critical thinking and the development of persuasive techniques by highlighting the strengths and areas for improvement in the content itself. As can be appreciated, the qualitative feedback 1220 may aid the student 305 in refining his or her ideas, enhancing logical flow, and strengthening their overall argumentation. In contrast, quantitative feedback, the backbone of conventional approaches, while valuable for improving measurable variables like timing, pacing, and delivery, does not address the underlying effectiveness of the speech's 307 message. By focusing the qualitative feedback 1220, the discourse engine 308 ensures that the student 305 is not only proficient in his or her delivery but also compelling and persuasive in content and substance.

In some embodiments, in addition to the illustrated feedback on the GUI 1200, the discourse engine 308 may generate a transcript of the speech 307 and include feedback on the transcript. In such cases, the GUI 1200 may include an option 1275 to “see transcript.” Upon selection of the option 1275 by a cursor 1250, a respective transcript of the speech 307 may be provided.

Referring now to FIG. 13, an example transcript 1300 of a speech, such as the speech 307, is illustrated, according to an embodiment herein. The transcript 1330 may be an illustrative transcript portion of the content 330 from the speech 307 and may be provided to the student 305 via the client device 304 upon selection of the option 1275. In some embodiments, the transcript generator 332 may generate the transcript 1330 based on the content 330 which may be an audio signal or recording of the speech 307.

In some embodiments, qualitative feedback may be provided in association with the transcript 1330. For example, the discourse engine 308 may highlight a section of the transcript 1330, such as section 1376. The highlighting of a respective section may be color coded, such to indicate feedback. In some embodiments, a color coding of the highlighting may indicate a positive feedback, neutral feedback, or a negative feedback. For example, a green highlight may indicate a section of the speech 307 in which the student 305 performed well, a yellow highlight may indicate a section of the speech 307 that had a neutral performance, and a red highlight may indicate a section of the speech 307 in which the student 305 could improve.

In addition, or in the alternative, the discourse engine 308 may provide a pop-up 1377 that provides qualitative feedback with respect to a specific section, such as the section 1376 of the transcript 1300. For example, as illustrated, the pop-up 1377, provides the qualitative feedback 1271 on the clarity of delivery for the speech 307. Advantageously, the pop-up 1377 indicates the specific section 1376 the qualitative feedback 1271 is referencing, thereby providing the student 305 context for the feedback 1271. As can be appreciated, indicating which section the qualitative feedback 1271 is associated with can enhance the student's 305 appreciation of the feedback. It should be appreciated that while FIG. 13 illustrates a single qualitative feedback area, in other cases, the transcript 1300 may include multiple qualitative feedbacks, such as indicating each respective section within the transcript 1300 that the qualitative feedback 1220 relates to.

Returning now back to FIG. 3, the following discussion is with respect to selection of a debate exercise 321. Although this discussion is provided subsequent to the discussion relating to the speech exercise 319, it should be appreciated that one or more aspects or steps of the above discussion (e.g., the process 400) are equally applicable to the remaining discussion (e.g., the process 500).

To start, the discourse engine 308 may receive an indication to start the debate exercise 321 (502). The indication to start the debate exercise 321 may be similar to the indication to start the speech exercise 319, such as by receiving a selection by the client device 304 of the debate exercise 321 with the discourse application 322. Responsive to receiving the indication, the discourse engine may determine a debate type 325 for the debate exercise 321. Similar to selection of the speech type 323, in some embodiments, the debate type 325 may be determined by the client device 306, the discourse engine 308, or the client device 304.

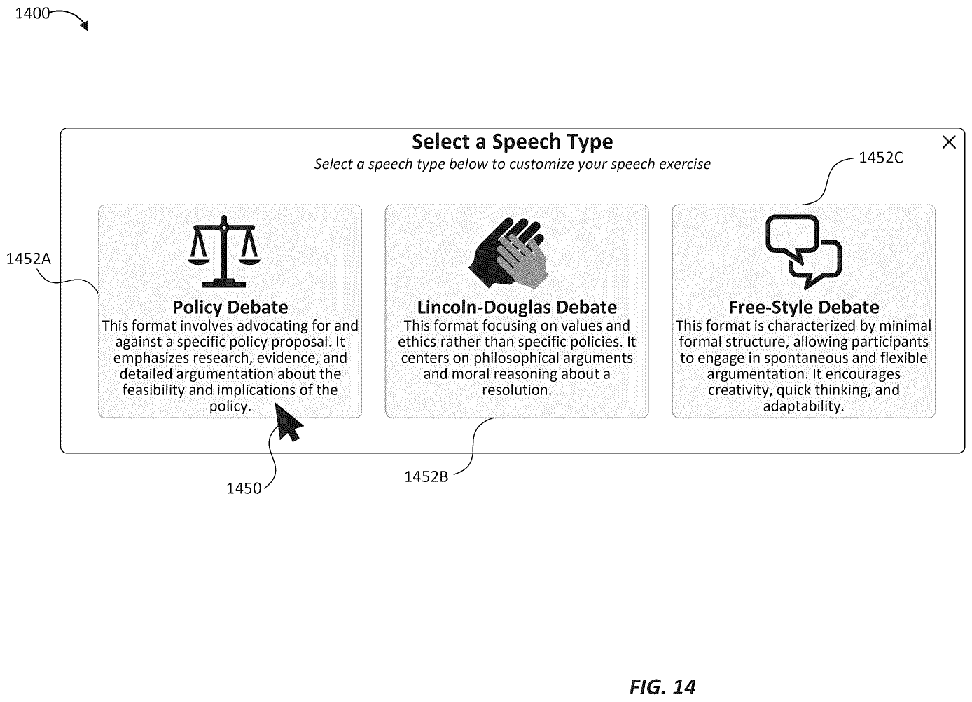

Referring now to FIG. 14, an example prompt 1400 of various debate types 1452A-C are illustrated, according to an embodiment herein. The prompt 1400 may be generated by the discourse engine 308 and provided to the client device 304, such as via the discourse application 322. As shown, the prompt 1400 includes three debate types 1452A-C from which the student 305 can select for the debate exercise 321. The debate type 1452A is for a policy debate, the debate type 1452B is for a Lincoln-Douglas debate, and the debate type 1452C is for a free-style debate. Each of the debate types 1452A-C provides a description of what the respective debate type entails. It should be appreciated that the debate types 1452A-C are illustrative and any other debate types, as well as any number of debate types may be provided via the prompt 1400.

In some embodiments, in addition or instead, the discourse engine 308 may determine a debate topic for the debate exercise 321 (504). That is, in some embodiments, the debate exercise 321 may not provide any options on debate type and instead take the format of free-style, open discourse. In such cases, the discourse engine 308 may determine a debate topic for the debate exercise 321. In some embodiments, the reviewing user, such as an educator, may assign a topic for the debate exercise 321, while in other embodiments, the student 305 may select a debate topic for the debate exercise 321. For example, the student 305 may be provided with the prompt 700 to select one of the topics 756A-C as a debate topic for the debate exercise 321. As described above, the student 305 may select the option 754 to generate additional topics for the debate exercise 321 if none of the provided topics 756A-C is of interest.

In some embodiments, one or more qualitative aspects may be determined by the discourse engine 308 for the debate exercise 321 (506). For example, one or more of the prompts 800-1000 may be provided to the student 305, as described above. Similar to the speech exercise 319, the qualitative aspects for the debate exercise 321 may be generated based on the debate type 325, the debate topic, and/or user profile information associated with the student 305. Additionally, as noted above, in some embodiments, the student 305 may select the qualitative aspects, while in other embodiments the reviewing user may select them and/or the discourse engine 380 may select the qualitative aspects used to evaluate the debate exercise 321.

Once a debate topic is determined, the debate exercise 321 may start. During the debate exercise 321 the student 305 may speak, such as via speech 307, to deliver his or her stance on the debate topic. That is, when the debate exercise 321 initiates, the student 305 may make an initial statement on the debate topic, taking a stance on the respective topic. In some cases, the initial statement may be made verbally, such as via the speech 307, that is captured by the microphone 309, as described above. In some embodiments, the discourse made by the student 305 during the debate exercise 321 may be made verbally or in writing. If made verbally, then the student's 305 discourse may be an audio and/or video stream or recording, as described above. If the student's 350 discourse is made in writing, then the student 305 may generate text via the discourse application 322. For ease of explanation, the following focuses on the student 305 speaking (e.g., making speech 307) for discourse during the debate exercise 321.

As described above, as the student 305 participates in the debate exercise 321, the content 330 associated with the speech 307 may be received by the discourse engine 308. As such, the discourse engine 308 may determine debate content from the content 330 (508). The debate content may be a segment of the content 330 associated with the student's 305 statement of the respective debate topic. That is, a debate typically entails a back and forth between two parties, here the student 305 and the discourse engine 308, each making statements regarding a particular stance. Usually, a follow-up statement retorts or provides a counterpoint to a previously received statement. As such, the discourse engine 308 may need to determine what portion of the content 330 corresponds to a completed statement on the debate topic, which is referred to herein as the debate content.

As can be appreciated, the content 330 may be a continuous stream, such as an audio stream, of the student's 305 speech 307 received by the discourse engine 308 (510). As such, the debate engine 308 may need to determine what portion of the speech 307, or the content 330 respectively, corresponds to the debate content. The discourse engine 308 may determine when the student 305 has finished making a statement (e.g., debate content) within an audio stream received from the client device 304 by analyzing various linguistic and acoustic cues. These may include pauses, changes in intonation, and natural cadence of speech. In some embodiments, the discourse engine 308 may use contextual understanding of the content 330 to identify sentence boundaries and topic shifts, ensuring accurate detection of statement completion. In an example, the discourse engine 308 may determine a start time and an end time for the speech 307, such as determining when the student 305 begins speaking and a subsequent break or pause in the student's 305 speech 307. The discourse engine 308 may then determine that the content 330 corresponding to when the student 305 began speaking to the break or pause corresponds to the debate content.

Once the debate content is determined, the discourse engine 308 may generate a transcript of the debate content. For example, the transcript generator 332 of the discourse engine 308 may generate a transcript of the debate content. Using the transcript, the discourse engine 308 may generate a debate response to the debate content (512). For example, the prompt generator 326 may generate a response prompt comprising the transcript of the debate content, along with the debate type 325, debate topic, and/or user profile information (514). The response prompt may be provided to the content generator 312, which may generate a debate response responsive to receiving the response prompt (516). Depending on the type of content generator 312, an audio stream or signal of the content 330 may be provided to the content generator 312 for generation of the debate response. Once generated, the debate response may be provided to the client device 304 via an audio signal and/or text. That is, the debate response may be visually displayed on the client device 304 or played via a speaker 340 on the client device 304.

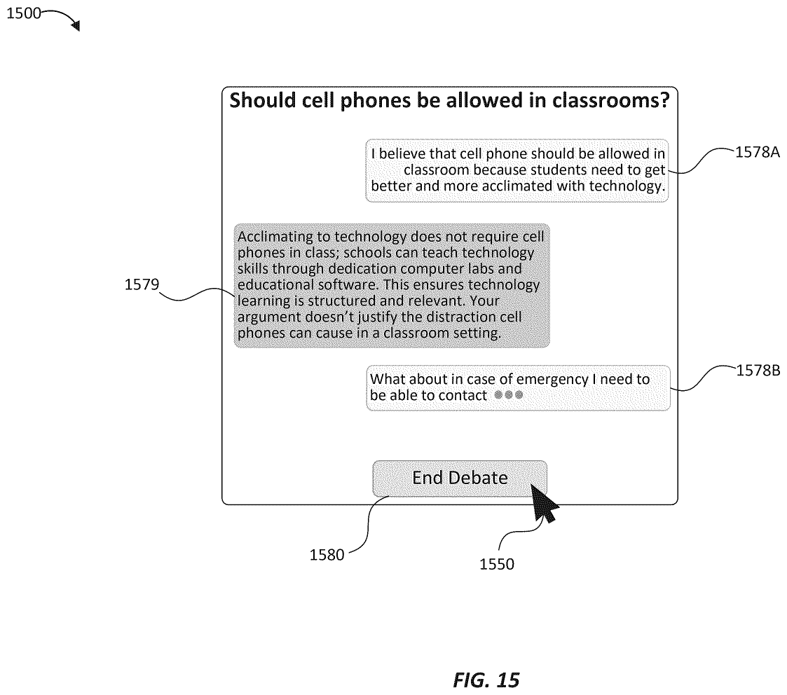

Referring now to FIG. 15, an example prompt 1500 illustrating debate content and debate responses exchanged between the student 305 and the discourse engine 308 during the debate exercise 321 is illustrated, according to an embodiment herein. The prompt 1500 may be generated by the discourse engine 308 as the student 305 participates in the debate exercise 321. For example, as the student 305 speaks, the speech 307 may be transcribed and displayed via the prompt 1500 on the client device 304. In this manner, the student 305 can maintain context on his or her stance and the responses generated by the discourse engine 308. In other embodiments, the prompt 1500 may only be generated upon completion of the debate exercise 321 for context of the qualitative feedback.

As noted above, the debate exercise 321 may entail a series of statements exchanged between the student 305 and the discourse engine 308. As such, the prompt 1500 may include a first debate content 1578A made by the student 305 and a debate response 1579 generated by the discourse engine 308. Responsive to receiving the debate response 1579, the student 305 may respond with a second debate content 1578B, such as to retort or counter the debate response 1579. Although not illustrated, the discourse engine 308 may generate a subsequent debate response to counter the second debate content 1578B. As can be appreciated, debate content and debate responses may be exchanged between the student 305 and the discourse engine 308 until the debate exercise 321 completes.

The discourse engine 308 may determine that the debate exercise 321 is completed via various methods. For example, the prompt 1500, if provided to the client device 304 may include an option 1580 to end the debate. In other embodiments, the debate exercise 321 may be timed, meaning that once the time expired, the debate exercise 321 closes. Regardless, once the discourse engine 308 determines that the debate exercise 321 completes, the discourse engine 308 may generate qualitative feedback based on the student's 305 performance during the debate exercise 321 (518).

The discourse engine 308 may generate qualitative feedback 348 for the debate exercise 321 using similar techniques as described above with respect to the speech exercise 319. For example, the discourse engine 308 may generate a quality feedback for each of the selected qualitative aspects (320) and, in some embodiments, generate a quality recommendation for one or more of the qualitative aspects (322). As such, the discourse engine 308 may generate qualitative feedback 348 that is similar or the same as the qualitative feedback 1220.

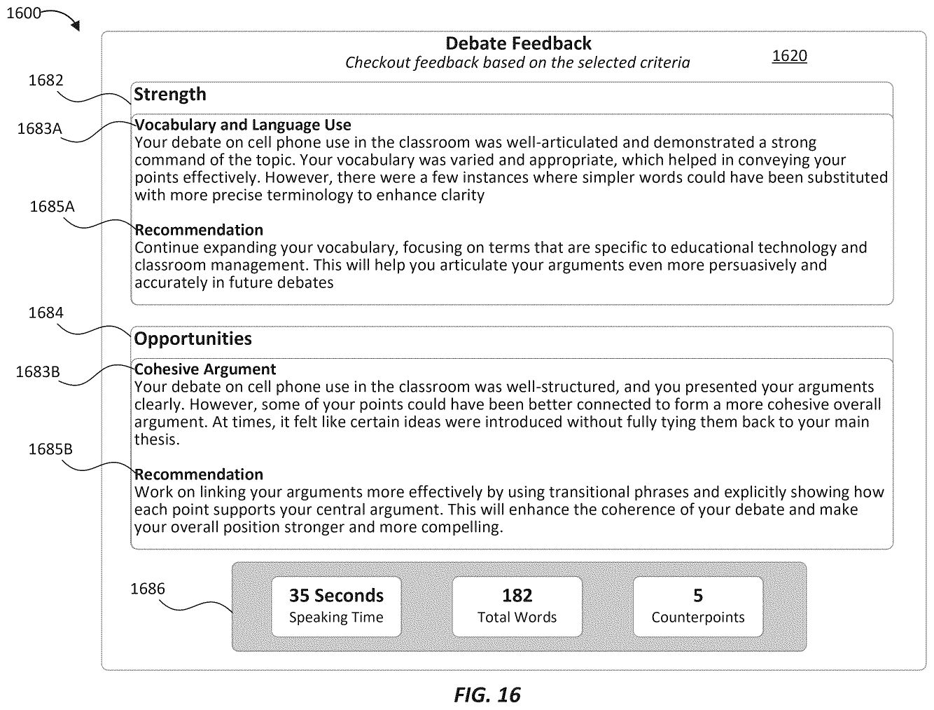

Referring now to FIG. 16, an example prompt 1600 illustrating qualitative feedback 1620 generated by the discourse engine for the debate exercise 321 is provided, according to an embodiment herein. As shown, the qualitative feedback 1620 provides a quality feedback 1683A-B and a quality recommendation 1685A-B for each of the selected qualitative aspects, which as illustrated include “Vocabulary and Language Use” and “Cohesive Argument.” The qualitative feedback 1620 is organized such as to identify an overall strength 1682 of the student's 305 debate performance and opportunities for improvement 1684. That is, the discourse engine 308 organizes the qualitative feedback 1620 such to identify that the student's 305 strength 1682 was his or her vocabulary and language use, but that the student 305 has room to improve on providing a cohesive argument. The prompt 1600 illustrates another example of how the discourse engine 308 may provide the qualitative feedback 1620 to the client device 304.

In addition to providing the quality feedback 1682A-B and the quality recommendations 1685A-B, the prompt 1600 may include quantitative feedback 1682. The quantitative feedback 1682 may include measurable aspects such as timing, pacing, frequency of filler words, volume, and adherence to the prescribed format. Quantitative feedback provides objective data on the technical execution of the student's 305 performance on the debate exercise 321. As noted above, by providing both the qualitative feedback 1620 and the quantitative feedback 1682, the discourse engine can provide feedback and critique on all aspects of the student's 305 performance. It should be appreciated, that while the quantitative feedback 1682 is discussed with respect to the debate exercise 321, the quantitative feedback 1682 may also be provided as part of the speech exercise 319.

As can be appreciated, the qualitative nature and substance of the debate exercise 321 may differ from those of the speech exercise 319 in several key ways. In a debate, participants must engage with opposing viewpoints, requiring a dynamic exchange of arguments and rebuttals. This necessitates not only a thorough understanding of the topic but also the ability to think critically and respond swiftly to counterarguments. As such, the qualitative aspects evaluated for the debate exercise 321 may focus on the depth of analysis, the effectiveness of rebuttals, and the strategic use of evidence. In contrast, the qualitative aspects of the speech exercise 319 may involve an emphasis on clarity, persuasiveness, and the overall coherence of the narrative. As such, the qualitative feedback generated for the debate exercise 321 may be different from the qualitative feedback generated for the speech exercise 319.

Once generated, the qualitative feedback 348 may be provided to the client device 304 (524). In some embodiments, however, the discourse engine 308 may first generate debate feedback 342 that includes the qualitative feedback generated by the content generator 312 as described above and send the debate feedback 342 to a reviewing user, such as via the client device 306 (526). The user of the client device 306 may review the debate feedback 342 for accuracy, consistency, and appropriateness. Upon review, the client device 306 may provide input 344 of the debate feedback 342 and transmit the input 344 to the discourse engine 308 (328). In some embodiments, the input 344 may be approval of the debate feedback 342, and as such, the debate feedback 342 may be the same or similar to the qualitative feedback 348. In some cases, a transcript of the debate exercise 321, such as the prompt 1500, may be generated by the transcript generator 332 and provided to the client device 304.

When the client device 304 receives the qualitative feedback 348, responsive to either the speech exercise 319 or the debate exercise 321, the qualitative feedback 348 may be displayed via the discourse application 322 for the student's 305 review. In this manner, the discourse engine 308 can provide qualitative feedback on a forensic exercise to the student 305 in a swift and efficient manner. By providing the qualitative feedback 348 to the student 305 directly after the exercise, the discourse engine 308 ensures that insights and critiques are fresh in the student's 305 mind. This immediate feedback allows for quicker implementation of suggestions and recommendation, reinforcing learning and facilitating continuous improvement in the student's 305 communication skills.

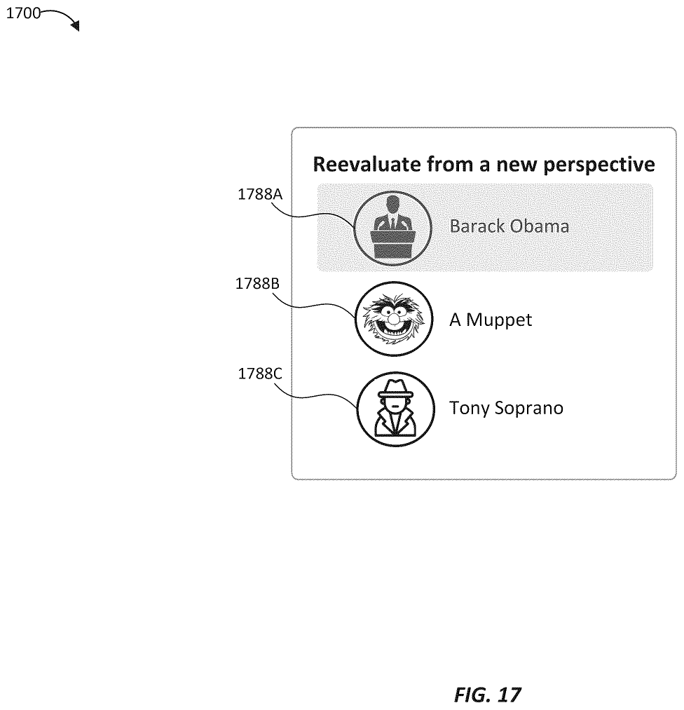

In some embodiments, to enhance engagement of the student 305 with the qualitative feedback 348, an alternative persona may be selected for providing the qualitative feedback 348. Referring now to FIG. 17, a prompt 1700 providing example alternative personas 1788A-C that may be selected for providing the qualitative feedback 348 is illustrated, according to an embodiment herein. As illustrated, the alternative personas 1788A-C include the president, Barack Obama 1788A, a Muppet 1788B, and a TV character Tony Soprano 1788C. The client device 304 may be provided with the prompt 1700 and may select a desired alternative persona 1788A-C. Here, the student 305 selects Tony Soprano 1788C. Responsive to the selection, the discourse engine 308 may generate the qualitative feedback 348 in the selected alternative persona. For example, if the student 305 selects the alternative persona of the Barack Obama 1788A, the qualitative feedback 348 may be provided in the Barack Obama's 1788A voice and vernacular, such as “Your speech was truly impressive. You articulated your ideas clearly and with conviction, and it's evident that you put a lot of thought into your message. Keep honing your skills, and you'll continue to inspire and engage your audience.”

In particular, the discourse engine 308 may include an alternative persona generator 346 which may coordinate with the prompt generator 326 to generate a persona prompt that requests that the qualitative feedback 348 be regenerated in the persona of Tony Soprano 1788C. Once submitted to the content generator 312, the qualitative feedback 348 may be regenerated as if Tony Soprano 1788C was giving the feedback. That is, the qualitative feedback 348 may be regenerated such that the language, tone, and style are adjusted to reflect the unique voice and characteristics of the selected persona, here Tony Soprano 1788C, making the qualitative feedback 348 more engaging and relatable to the student 305.

By generating the qualitative feedback 348 from an alternative persona, the qualitative feedback 348 may be better appreciated or more effectively taken by the student 305. That is, the student 305 may be more engaged and receptive to the qualitative feedback 348 when it is delivered by a particular person or character, such as a beloved Muppet or a respected figure like the president. When the qualitative feedback 348 comes from a trusted or admired source, it can create a sense of connection and engagement that makes the student 305 more receptive to the advice given. The familiar and positive association with the character or person can reduce defensiveness and increase openness to constructive criticism. Additionally, the unique perspective and perceived authority of such figures can lend greater weight to the qualitative feedback 348, making it feel more valuable and impactful. This approach leverages the power of relatability and authority to enhance the student's 305 motivation to improve and apply the qualitative feedback 348 effectively

Referring to FIG. 18, FIG. 18 illustrates a computing system 1891 that may be used for providing a discourse engine and related functions, as described herein. For example, the client devices 102, 104, or 106 may be or include the computing system 1891. As illustrated, the computing system 1891 includes a processing system 1892 that includes a microprocessor and other circuitry that retrieves and executes software 1895 from storage system 1893. The processing system 1892 may be implemented within a single processing device but may also be distributed across multiple processing devices or sub-systems that cooperate in executing program instructions. Examples of the processing system 1892 include general purpose central processing units, graphical processing units, application specific processors, and logic devices, as well as any other type of processing device, combinations, or variations thereof.

The storage system 1893 may comprise any computer readable storage media readable by processing system 1892 and capable of storing software 1895. The storage system 1893 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 1893 may also include computer readable communication media over which at least some of the software 1895 may be communicated internally or externally. The storage system 1893 may be implemented as a single storage device but may also be implemented across multiple storage devices or sub-systems co-located or distributed relative to each other. The storage system 1893 may comprise additional elements, such as a controller capable of communicating with the processing system 1892 or possibly other systems.

The software 1895 (including discourse engine process 1896) may be implemented in program instructions and among other functions may, when executed by the processing system 1892, direct the processing system 1892 to operate as described with respect to the various operational scenarios, sequences, and processes illustrated herein. For example, the software 1895 may include program instructions for implementing a discourse engine and related functions, as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 1895 may include additional processes, programs, or components, such as operating system software, virtualization software, or other application software. The software 1895 may also comprise firmware or some other form of machine-readable processing instructions executable by the processing system 1892.

In general, the software 1895 may, when loaded into the processing system 1892 and executed, transform a suitable apparatus, system, or device (of which computing system 1891 is representative) overall from a general-purpose computing system into a special-purpose computing system customized to generate features, functionality, and user experiences provided by the discourse engine. Indeed, encoding the software 1895 on the storage system 1893 may transform the physical structure of the storage system 1893. The specific transformation of the physical structure may depend on various factors in different implementations of this description. Examples of such factors may include, but are not limited to, the technology used to implement the storage media of the storage system 1893 and whether the computer-storage media are characterized as primary or secondary storage, as well as other factors.

For example, if the computer readable storage media are implemented as semiconductor-based memory, the software 1895 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1897 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 1891 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a discourse engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: one or more computer readable storage media; one or more processors operatively coupled with the one or more computer readable storage media; and an application comprising program instructions stored on the one or more computer readable storage media that, when executed by the one or more processors, direct a computing system to at least: identify, by a discourse engine, an indication to start a speech exercise for a client device; determine, by a discourse engine, a speech type for the speech exercise; determine, by the discourse engine, one or more qualitative aspects for speech feedback; receive, by the discourse engine, first speech content from the client device; generate, by the discourse engine, first speech feedback based on the one or more qualitative aspects and the first speech content; and provide, by the discourse engine, the first speech feedback to the client device.

Example 2 is the system of any previous or subsequent Example, wherein the program instructions to generate, by the discourse engine, the first speech feedback based on the one or more qualitative aspects cause, when executed by the one or more processors, to further direct the computing system to: generate, by the discourse engine, a feedback prompt comprising the first speech content; transmit, by the discourse engine, the feedback prompt to a content generator; and receive, by the discourse engine, the first speech feedback from the content generator.

Example 3 is the system of any previous or subsequent Example, wherein the program instructions to receive, by the discourse engine, the first speech content from the client device cause, when executed by the one or more processors, to further direct the computing system to: receive, by the discourse engine, an audio signal of a user's speech; and generate, by the discourse engine, a transcript of the audio signal, wherein the first speech content comprises the transcript.

Example 4 is the system of any previous or subsequent Example, wherein the program instructions to generate, by the discourse engine, the first speech feedback based on the one or more qualitative aspects cause, when executed by the one or more processors, to further direct the computing system to: generate, by the discourse engine, a quality feedback for each qualitative aspect of the one or more quality aspects; and generate, by the discourse engine, a quality recommendation for each qualitative aspect of the one or more quality aspects.

Example 5 is the system of any previous or subsequent Example, wherein the program instructions to generate, by the discourse engine, the first speech feedback based on the one or more qualitative aspects cause, when executed by the one or more processors, to further direct the computing system to: generate, by the discourse engine, a transcript of an audio signal associated with a user's speech; identify, by the discourse engine, one or more sections within the transcript based on the one or more qualitative aspects; and generate, by the discourse engine, qualitative feedback based on the one or more sections within the transcript, wherein: the qualitative feedback comprises highlighting the one or more sections within the transcript and providing a recommendation based on the one or more sections; and the first speech feedback comprises the qualitative feedback.

Example 6 is the system of any previous or subsequent Example, wherein the program instructions cause, when executed by the one or more processors, to further direct the computing system to: provide, by the discourse engine, the first speech feedback to a second client device; receive, by the discourse engine, input on the first speech feedback from the second client device; and responsive to receiving the input from the second client device, transmit, by the discourse engine, the first speech feedback to the client device.

Example 7 is a method comprising: receiving, from a client device, an indication to start a speech exercise; determining, by a discourse engine, a speech type for the speech exercise; determining, by the discourse engine, one or more qualitative categories for speech feedback; determining, by the discourse engine, one or more qualitative aspects per the one or more qualitative categories for the speech feedback; receiving, by the discourse engine, first speech content from the client device; generating, by the discourse engine, first speech feedback based on the one or more qualitative aspects and the first speech content; and providing, by the discourse engine, the first speech feedback to the client device.

Example 8 is the method of any previous or subsequent Example, wherein generating, by the discourse engine, the first speech feedback based on the one or more qualitative aspects comprises: generating, by the discourse engine, a feedback prompt comprising the one or more qualitative aspects and the first speech content; providing, by the discourse engine, the feedback prompt to a content generator, wherein the content generator generates the first speech feedback responsive to receiving the feedback prompt; and receiving, by the discourse engine, the first speech feedback from the content generator.

Example 9 is the method of any previous or subsequent Example, wherein receiving, by the discourse engine, the first speech content from the client device further comprises: receiving, by the discourse engine, an audio signal from the client device; generating, by the discourse engine, a transcript of the audio signal, wherein the first speech content comprises the transcript.

Example 10 is the method of any previous or subsequent Example, wherein generating, by the discourse engine, the first speech feedback based on the one or more qualitative aspects comprises: generating, by the discourse engine, a quality feedback for each qualitative aspect in the one or more qualitative categories based on the first speech content; and generating, by the discourse engine, a quality recommendation for each qualitative aspect in the one or more qualitative categories based on the first speech content.

Example 11 is the method of any previous or subsequent Example, wherein generating, by the discourse engine, the first speech feedback based on the one or more qualitative aspects further comprises: generating, by the discourse engine, a transcript of an audio signal associated with a user's speech; identifying, by the discourse engine, one or more sections within the transcript based on the one or more qualitative aspects; and generating, by the discourse engine, qualitative feedback based on the one or more sections within the transcript, wherein: the qualitative feedback comprises highlighting the one or more sections within the transcript and providing a recommendation based on the one or more sections; and the first speech feedback comprises the qualitative feedback.

Example 12 is the method of any previous or subsequent Example, wherein determining, by the discourse engine, the one or more qualitative categories for speech feedback comprises: generating, by the discourse engine, a category prompt based on the speech type; providing, by the discourse engine, the category prompt to a content generator; and receiving, by the discourse engine, the one or more qualitative categories for the speech feedback from the content generator.

Example 13 is the method of any previous or subsequent Example, wherein: the method further comprises determining, by the discourse engine, a topic of the speech exercise; and generating, by the discourse engine, the first speech feedback based on the one or more qualitative aspects further comprises generating, by the discourse engine, the first speech feedback based on the one or more qualitative aspects and the topic of the speech exercise.

Example 14 is the method of any previous or subsequent Example, the method further comprising: providing, by the discourse engine, the first speech feedback to a second client device; receiving, by the discourse engine, input on the first speech feedback from the second client device; and responsive to receiving the input from the second client device, providing, by the discourse engine, the first speech feedback to the client device.

Example 15 is a computer readable storage media comprising processor-executable instructions configured to cause one or more processors to: determine, by a discourse engine, an indication to start a speech exercise for a client device; determine, by a discourse engine, a speech type for the speech exercise; determine, by the discourse engine, one or more qualitative categories for speech feedback; determine, by the discourse engine, one or more qualitative aspects for each of the one or more qualitative categories for speech feedback; receive, by the discourse engine, first speech content from the client device; generate, by the discourse engine, first speech feedback based on the one or more qualitative aspects and the first speech content; and provide, by the discourse engine, the first speech feedback to the client device.

Example 16 is the computer readable storage media of any previous or subsequent Example, wherein the processor-executable instructions to generate, by the discourse engine, the first speech feedback based on the one or more qualitative aspects cause the one or more processors to further execute processor-executable instructions stored in the computer readable storage media to: generate, by the discourse engine, a feedback prompt comprising the first speech content and the one or more qualitative aspects; and submit, by the discourse engine, the feedback prompt to a content generator, wherein the content generator generates the first speech feedback responsive to receiving the feedback prompt.

Example 17 is the computer readable storage media of any previous or subsequent Example, wherein the processor-executable instructions to receive, by the discourse engine, the first speech content from the client device cause the one or more processors to further execute processor-executable instructions stored in the computer readable storage media to: receive, by the discourse engine, a transcript of an audio signal of a user's speech, wherein the first speech content comprises the transcript.

Example 18 is the computer readable storage media of any previous or subsequent Example, wherein the processor-executable instructions to determine, by the discourse engine, the one or more qualitative categories from the speech feedback cause the one or more processors to further execute processor-executable instructions stored in the computer readable storage media to: determine, by the discourse engine, a user profile associated with the client device; generate, by the discourse engine, a category prompt based on the speech type and the user profile, wherein the category prompt requests qualitative categories for giving speech feedback based on the speech type; provide, by the discourse engine, the category prompt to a content generator, wherein the content generator generates the one or more qualitative categories responsive to the category prompt; and receive, by the discourse engine, the one or more qualitative categories for the speech feedback from the content generator.

Example 19 is the computer readable storage media of any previous or subsequent Example, wherein the processor-executable instructions to generate, by the discourse engine, the first speech feedback based on the one or more qualitative aspects cause the one or more processors to further execute processor-executable instructions stored in the computer readable storage media to: generate, by the discourse engine, qualitative speech feedback based on the first speech content and the one or more qualitative aspects; provide, by the discourse engine, the qualitative speech feedback to a second client device; receive, by the discourse engine, input on the qualitative speech feedback from the second client device; and responsive to receiving the input from the second client device, generate, by the discourse engine, the first speech feedback based on the input to the qualitative speech feedback.

Example 20 is the computer readable storage media of any previous or subsequent Example, wherein the processor-executable instructions to determine, by the discourse engine, the one or more qualitative aspects for each of the one or more qualitative categories for speech feedback cause the one or more processors to further execute processor-executable instructions stored in the computer readable storage media to: determine, by the discourse engine, a topic for the speech exercise; generate, by the discourse engine, an aspects prompt based on the speech type and the topic of the speech exercise, wherein the category prompt requests qualitative aspects for giving speech feedback based on the speech type; provide, by the discourse engine, the aspects prompt to a content generator, wherein the content generator generates the one or more qualitative aspects responsive to the category prompt; and receiving, by the discourse engine, the one or more qualitative aspects for the speech feedback from the content generator.

Example 21 is a system comprising: one or more computer readable storage media; one or more processors operatively coupled with the one or more computer readable storage media; and an application comprising program instructions stored on the one or more computer readable storage media that, when executed by the one or more processors, direct a computing system to at least: receive, from a client device, an indication to start a debate exercise; determine, by a discourse engine, a first debate topic for the debate exercise; determine, by the discourse engine, first debate content from the client device; generate, by the discourse engine, first response content based on the first debate content and the first debate topic; determine, by the discourse engine, one or more qualitative aspects for providing debate feedback to the client device; generate, by the discourse engine, debate feedback based on the first debate content and the one or more qualitative aspects; and provide, by the discourse engine, the debate feedback to the client device.

Example 22 is the system of any previous or subsequent Example, wherein the program instructions to generate, by the discourse engine, the first response content based on the first debate topic cause, when executed by the one or more processors, to further direct the computing system to: generate, by the discourse engine, a transcript of the first debate content; generate, by the discourse engine, a first response prompt comprising the transcript of the first debate content; submit, by the discourse engine, the first response prompt to a content generator; and receive, by the discourse engine, the first response content from the content generator, wherein the content generator generates the first response content responsive to the first response prompt.

Example 23 is the system of any previous or subsequent Example, wherein the program instructions to receive, by the discourse engine, the first debate content from the client device cause, when executed by the one or more processors, to further direct the computing system to: receive, by the discourse engine, an audio signal of a user's speech; and generate, by the discourse engine, a transcript of the audio signal, wherein the first debate content comprises the transcript.

Example 24 is the system of any previous or subsequent Example, wherein the program instructions to determine, by the discourse engine, the first debate topic for the debate exercise cause, when executed by the one or more processors, to further direct the computing system to: determine, by the discourse engine, a user profile associated with the client device; and generating, by the discourse engine, one or more debate topics based on the debate type and the client device, wherein the debate topics comprise the first debate topic.

Example 25 is the system of any previous or subsequent Example, wherein: the program instructions cause, when executed by the one or more processors, to further direct the computing system to receiving, by the discourse engine, second debate content from the client device responsive to the first response content; and the program instructions to generate, by the discourse engine, the debate feedback based on the first debate content and the one or more qualitative aspects cause, when executed by the one or more processors, to further direct the computing system to: generate, by the discourse engine, the debate feedback based on the first debate content, the second debate content, and the one or more qualitative aspects.

Example 26 is the system of any previous or subsequent Example, wherein the program instructions cause, when executed by the one or more processors, to further direct the computing system to: provide, by the discourse engine, the debate feedback to a second client device; receive, by the discourse engine, input on the debate feedback from the second client device; and responsive to receiving the input from the second client device, transmit, by the discourse engine, the debate feedback to the client device.

Example 27 is a method comprising: receiving, from a client device, an indication to start a debate exercise; determining, by a discourse engine, a first debate topic for the debate exercise; receiving, by the discourse engine, first debate content from the client device; generating, by the discourse engine, first response content based on the first debate content and the first debate topic; determining, by the discourse engine, one or more qualitative aspects for providing debate feedback to the client device; generating, by the discourse engine, debate feedback based on the first debate content and the one or more qualitative aspects; and providing, by the discourse engine, the debate feedback to the client device.

Example 28 is the method of any previous or subsequent Example, wherein the method further comprises: determining, by the discourse engine, a content stream from the client device, wherein the content stream comprises a start time; determining, by the discourse engine, an end time of the content stream from the client device; and determining, by the discourse engine, the first debate content based on the start time and the end time of the content stream.

Example 29 is the method of any previous or subsequent Example, wherein receiving, by the discourse engine, the first debate content from the client device further comprises: receiving, by the discourse engine, an audio signal from the client device; and generating, by the discourse engine, a transcript of the audio signal, wherein the first debate content comprises the transcript.

Example 30 is the method of any previous or subsequent Example, wherein generating, by the discourse engine, the debate feedback based on the one or more qualitative aspects and the first debate content comprises: generating, by the discourse engine, a quality feedback for each qualitative aspect in the one or more qualitative aspects based on the first debate content; and generating, by the discourse engine, a quality recommendation for each qualitative aspect in the one or more qualitative aspects based on the first debate content.

Example 31 is the method of any previous or subsequent Example, wherein the method further comprises: generating, by the discourse engine, one or more debate topics based on the debate type, wherein the debate topics comprise the first debate topic.

Example 32 is the method of any previous or subsequent Example, wherein generating, by the discourse engine, the first response content based on the first debate content and the first debate topic comprises: generating, by the discourse engine, a first response prompt comprising the first debate content; providing, by the discourse engine, the first response prompt to a content generator; and receiving, by the discourse engine, the first response content from the content generator, wherein the content generator generates the first response content responsive to the first response prompt.

Example 33 is the method of any previous or subsequent Example, wherein generating, by the discourse engine, the debate feedback based on the first debate content and the one or more qualitative aspects comprises: generating, by the discourse engine, a feedback prompt comprising the one or more qualitative aspects and the first debate content; providing, by the discourse engine, the feedback prompt to a content generator, wherein the content generator generates the debate feedback responsive to receiving the feedback prompt; and receiving, by the discourse engine, the debate feedback from the content generator.

Example 34 is the method of any previous or subsequent Example, the method further comprising: providing, by the discourse engine, the debate feedback to a second client device; receiving, by the discourse engine, input on the debate feedback from the second client device; and responsive to receiving the input from the second client device, providing, by the discourse engine, the debate feedback to the client device.

Example 35 is a computer readable storage media comprising processor-executable instructions configured to cause one or more processors to: receive, from a client device, an indication to start a debate exercise; determine, by the discourse engine, a first debate topic for the debate exercise; determine, by the discourse engine, first debate content from the client device; generate, by the discourse engine, first response content based on the first debate content and the first debate topic; determine, by the discourse engine, one or more qualitative aspects for providing debate feedback to the client device; generate, by the discourse engine, debate feedback based on the first debate content and the one or more qualitative aspects; and provide, by the discourse engine, the debate feedback to the client device.

Example 36 is the computer readable storage media of any previous or subsequent Example, wherein the processor-executable instructions cause the one or more processors to further execute processor-executable instructions stored in the computer readable storage media to: determine, by the discourse engine, a content stream from the client device; and determine, by the discourse engine, the first debate content based on a break in the content stream.

Example 37 is the computer readable storage media of any previous or subsequent Example, wherein the processor-executable instructions to generate, by the discourse engine, the first response content based on the first debate content and the first debate topic cause the one or more processors to further execute processor-executable instructions stored in the computer readable storage media to: receive, by the discourse engine, a transcript of the first debate content; generate, by the discourse engine, a first response prompt comprising the transcript of the first debate content and instructions comprising the first debate topic; and submit, by the discourse engine, the first response prompt to a content generator, wherein the content generator generates the first response content responsive to the first response prompt.

Example 38 is the computer readable storage media of any previous or subsequent Example, wherein the processor-executable instructions to generate, by the discourse engine, the first response content based on the first debate content and the first debate topic cause the one or more processors to further execute processor-executable instructions stored in the computer readable storage media to: determine, by the discourse engine, a user profile associated with the client device; generate, by the discourse engine, a first response prompt based on the user profile, wherein the first response prompt comprises the first debate content and the first debate topic; provide, by the discourse engine, the first response prompt to a content generator; and receive, by the discourse engine, the first response content from the content generator, wherein the content generator generates the first response content responsive to the first response prompt.

Example 39 is the computer readable storage media of any previous or subsequent Example, wherein the processor-executable instructions to generate, by the discourse engine, the debate feedback based on the first debate content and the one or more qualitative aspects cause the one or more processors to further execute processor-executable instructions stored in the computer readable storage media to: generate, by the discourse engine, qualitative feedback based on the first debate content and the one or more qualitative aspects; provide, by the discourse engine, the qualitative feedback to a second client device; receive, by the discourse engine, input on the qualitative feedback from the second client device; and responsive to receiving the input from the second client device, generate, by the discourse engine, the debate feedback based on the input to the qualitative feedback.

Example 40 is the computer readable storage media of any previous or subsequent Example, wherein the processor-executable instructions to generate, by the discourse engine, the debate feedback based on the one or more qualitative aspects and the first debate cause the one or more processors to further execute processor-executable instructions stored in the computer readable storage media to: generate, by the discourse engine, a feedback prompt comprising the first debate content; transmit, by the discourse engine, the feedback prompt to a content generator; and receive, by the discourse engine, the debate feedback from the content generator.

What is claimed is:

1. A system comprising:
one or more computer readable storage media;
one or more processors operatively coupled with the one or more computer readable storage media; and
an application comprising program instructions stored on the one or more computer readable storage media that, when executed by the one or more processors, direct a computing system to at least:
receive, from a client device, an indication to start a debate exercise;
determine, by a discourse engine, a first debate topic for the debate exercise;
determine, by the discourse engine, first debate content from the client device;
generate, by the discourse engine, first response content based on the first debate content and the first debate topic;
determine, by the discourse engine, one or more qualitative aspects for providing debate feedback to the client device;
generate, by the discourse engine, debate feedback based on the first debate content and the one or more qualitative aspects; and
provide, by the discourse engine, the debate feedback to the client device.

2. The system of claim 1, wherein the program instructions to generate, by the discourse engine, the first response content based on the first debate topic cause, when executed by the one or more processors, to further direct the computing system to:
generate, by the discourse engine, a transcript of the first debate content;
generate, by the discourse engine, a first response prompt comprising the transcript of the first debate content;
submit, by the discourse engine, the first response prompt to a content generator; and
receive, by the discourse engine, the first response content from the content generator, wherein the content generator generates the first response content responsive to the first response prompt.

3. The system of claim 1, wherein the program instructions to receive, by the discourse engine, the first debate content from the client device cause, when executed by the one or more processors, to further direct the computing system to:
receive, by the discourse engine, an audio signal of a user's speech; and
generate, by the discourse engine, a transcript of the audio signal, wherein the first debate content comprises the transcript.

4. The system of claim 1, wherein the program instructions to determine, by the discourse engine, the first debate topic for the debate exercise cause, when executed by the one or more processors, to further direct the computing system to:
determine, by the discourse engine, a user profile associated with the client device; and
generating, by the discourse engine, one or more debate topics based on the debate type and the client device, wherein the debate topics comprise the first debate topic.

5. The system of claim 1, wherein:
the program instructions cause, when executed by the one or more processors, to further direct the computing system to receiving, by the discourse engine, second debate content from the client device responsive to the first response content; and
the program instructions to generate, by the discourse engine, the debate feedback based on the first debate content and the one or more qualitative aspects cause, when executed by the one or more processors, to further direct the computing system to:
generate, by the discourse engine, the debate feedback based on the first debate content, the second debate content, and the one or more qualitative aspects.

6. The system of claim 1, wherein the program instructions cause, when executed by the one or more processors, to further direct the computing system to:
provide, by the discourse engine, the debate feedback to a second client device;
receive, by the discourse engine, input on the debate feedback from the second client device; and
responsive to receiving the input from the second client device, transmit, by the discourse engine, the debate feedback to the client device.

7. A method comprising:
receiving, from a client device, an indication to start a debate exercise;
determining, by a discourse engine, a first debate topic for the debate exercise;
receiving, by the discourse engine, first debate content from the client device;
generating, by the discourse engine, first response content based on the first debate content and the first debate topic;
determining, by the discourse engine, one or more qualitative aspects for providing debate feedback to the client device;
generating, by the discourse engine, debate feedback based on the first debate content and the one or more qualitative aspects; and
providing, by the discourse engine, the debate feedback to the client device.

8. The method of claim 7, wherein the method further comprises:
determining, by the discourse engine, a content stream from the client device, wherein the content stream comprises a start time;
determining, by the discourse engine, an end time of the content stream from the client device; and
determining, by the discourse engine, the first debate content based on the start time and the end time of the content stream.

9. The method of claim 7, wherein receiving, by the discourse engine, the first debate content from the client device further comprises:
receiving, by the discourse engine, an audio signal from the client device; and
generating, by the discourse engine, a transcript of the audio signal, wherein the first debate content comprises the transcript.

10. The method of claim 7, wherein generating, by the discourse engine, the debate feedback based on the one or more qualitative aspects and the first debate content comprises:
generating, by the discourse engine, a quality feedback for each qualitative aspect in the one or more qualitative aspects based on the first debate content; and
generating, by the discourse engine, a quality recommendation for each qualitative aspect in the one or more qualitative aspects based on the first debate content.

11. The method of claim 7, wherein the method further comprises:
generating, by the discourse engine, one or more debate topics based on the debate type, wherein the debate topics comprise the first debate topic.

12. The method of claim 7, wherein generating, by the discourse engine, the first response content based on the first debate content and the first debate topic comprises:
generating, by the discourse engine, a first response prompt comprising the first debate content;
providing, by the discourse engine, the first response prompt to a content generator; and
receiving, by the discourse engine, the first response content from the content generator, wherein the content generator generates the first response content responsive to the first response prompt.

13. The method of claim 7, wherein generating, by the discourse engine, the debate feedback based on the first debate content and the one or more qualitative aspects comprises:
generating, by the discourse engine, a feedback prompt comprising the one or more qualitative aspects and the first debate content;
providing, by the discourse engine, the feedback prompt to a content generator, wherein the content generator generates the debate feedback responsive to receiving the feedback prompt; and
receiving, by the discourse engine, the debate feedback from the content generator.

14. The method of claim 7, the method further comprising:
providing, by the discourse engine, the debate feedback to a second client device;
receiving, by the discourse engine, input on the debate feedback from the second client device; and
responsive to receiving the input from the second client device, providing, by the discourse engine, the debate feedback to the client device.

15. A computer readable storage media comprising processor-executable instructions configured to cause one or more processors to:
receive, from a client device, an indication to start a debate exercise;
determine, by the discourse engine, a first debate topic for the debate exercise;
determine, by the discourse engine, first debate content from the client device;
generate, by the discourse engine, first response content based on the first debate content and the first debate topic;
determine, by the discourse engine, one or more qualitative aspects for providing debate feedback to the client device;
generate, by the discourse engine, debate feedback based on the first debate content and the one or more qualitative aspects; and
provide, by the discourse engine, the debate feedback to the client device.

16. The computer readable storage media of claim 15, wherein the processor-executable instructions cause the one or more processors to further execute processor-executable instructions stored in the computer readable storage media to:
determine, by the discourse engine, a content stream from the client device; and
determine, by the discourse engine, the first debate content based on a break in the content stream.

17. The computer readable storage media of claim 15, wherein the processor-executable instructions to generate, by the discourse engine, the first response content based on the first debate content and the first debate topic cause the one or more processors to further execute processor-executable instructions stored in the computer readable storage media to:
receive, by the discourse engine, a transcript of the first debate content;
generate, by the discourse engine, a first response prompt comprising the transcript of the first debate content and instructions comprising the first debate topic; and
submit, by the discourse engine, the first response prompt to a content generator, wherein the content generator generates the first response content responsive to the first response prompt.

18. The computer readable storage media of claim 15, wherein the processor-executable instructions to generate, by the discourse engine, the first response content based on the first debate content and the first debate topic cause the one or more processors to further execute processor-executable instructions stored in the computer readable storage media to:
determine, by the discourse engine, a user profile associated with the client device;
generate, by the discourse engine, a first response prompt based on the user profile, wherein the first response prompt comprises the first debate content and the first debate topic;
provide, by the discourse engine, the first response prompt to a content generator; and
receive, by the discourse engine, the first response content from the content generator, wherein the content generator generates the first response content responsive to the first response prompt.

19. The computer readable storage media of claim 15, wherein the processor-executable instructions to generate, by the discourse engine, the debate feedback based on the first debate content and the one or more qualitative aspects cause the one or more processors to further execute processor-executable instructions stored in the computer readable storage media to:
generate, by the discourse engine, qualitative feedback based on the first debate content and the one or more qualitative aspects;
provide, by the discourse engine, the qualitative feedback to a second client device;
receive, by the discourse engine, input on the qualitative feedback from the second client device; and
responsive to receiving the input from the second client device, generate, by the discourse engine, the debate feedback based on the input to the qualitative feedback.

20. The computer readable storage media of claim 15, wherein the processor-executable instructions to generate, by the discourse engine, the debate feedback based on the one or more qualitative aspects and the first debate cause the one or more processors to further execute processor-executable instructions stored in the computer readable storage media to:
generate, by the discourse engine, a feedback prompt comprising the first debate content;
transmit, by the discourse engine, the feedback prompt to a content generator; and
receive, by the discourse engine, the debate feedback from the content generator.
